(19) United States
(12) Patent Application Publication
(10) Pub. No.: US 2022/0215339 A1
(43) Pub. Date: Jul. 7, 2022

(54) AUTOMATIC HOUSEHOLD CONSUMABLE PRODUCT INVENTORY TRACKING AND RE-ORDER DEVICES, SYSTEMS, AND METHODS

(71) Applicant: GPCP IP HOLDINGS LLC, Atlanta, GA (US)

(72) Inventors: Brian Scott Borke, Appleton, WI (US); Deborah Kimberly Poe, Atlanta, GA (US); Ilana Jean Katz, Atlanta, GA (US); Stephen Russel Kobs, Greenville, WI (US); David Warren Murphy, Neenah, WI (US); Timothy Andrew Robertson, Appleton, WI (US); Alan Joseph Johnson, Brillion, WI (US); Scott Bradshaw, Marietta, GA (US); Bernard Neal Racine, Neenah, WI (US)

(21) Appl. No.: 17/606,812

(22) PCT Filed: May 21, 2020
(86) PCT No.: PCT/US2020/033944

§ 371 Date: Oct. 27, 2021

Related U.S. Application Data
(60) Provisional application No. 62/914,645, filed on Oct. 14, 2019.
(60) Provisional application No. 62/850,650, filed on May 21, 2019.
(60) Provisional application No. 62/971,501, filed on Feb. 7, 2020.

(51) Int. Cl. G06Q 10/08; G06Q 30/06

(52) U.S. Cl. CPC G06Q 10/0875; G06M 1/272; G06Q 30/0633

(57) ABSTRACT

Systems, devices, and methods for providing automated tracking and re-order functionality for household consumable products, such as sheet product rolls, napkins, plates, and bulk storage product are provided herein. Various devices (e.g., dispensers, spindles, storage devices, consumable product holders, etc.) include one or more sensors configured to determine the presence and/or usage of a consumable product and transmit that information to a remote device. The remote device keeps track of an inventory of the consumable product and, based on user preferences, initiates re-order functionality in response to a determination of a need to re¬order the consumable product. Such re-order functionality may include notifying the user, offering a pre-configured order, and automatically initiating the re-order. Various devices are also provided herein with sensor configurations that are usable with such systems. Corresponding software application configurations are also provided.

### CROSS-REFERENCE TO RELATED APPLICATIONS

This application claims priority to and is a 35 U.S.C. § 371 U.S. National Stage Application of International Application No. PCT/US2020/033944, entitled “Automatic Household Consumable Product Inventory Tracking and Re-Order Devices, Systems, and Methods”, filed May 21, 2020, which claims priority to U.S. Provisional Application No. 62/971,501, filed Feb. 7, 2020, entitled “Automatic Household Consumable Product Inventory Tracking and Re-Order Systems and Methods”; U.S. Provisional Application No. 62/914,645, filed Oct. 14, 2019, entitled “Automatic Household Consumable Product Inventory Tracking and Re-Order Systems and Methods”; and U.S. Provisional Application No. 62/850,650, filed May 21, 2019, entitled “Automatic Household Sheet Product Inventory Tracking and Re-Order Systems and Methods”; the contents of each being incorporated by reference herein in its entirety.

### FIELD OF THE INVENTION

Example embodiments of the present invention generally relate to inventory tracking and re-order systems and, more particularly to automatic household inventory tracking and re-order systems and methods for consumable products.

### BACKGROUND

It is often difficult for household members to remember when to order or buy household consumable products (e.g., sheet product, such as tissue paper rolls and paper towel rolls; napkins; paper plates; bulk storage products, such as dog food, cereal, and garden and home maintenance products; fluid product, such as soap, juice, soda, and air freshener; etc.). Consumers have to keep track of their current supply of consumable products, keeping in mind when they will next be at the store or when to place an order. Further, in the case of online ordering, they have to account for delivery time. Some subscription based models that re-order after a certain period of time are difficult to use and often ship too much or too little of the consumable product—resulting in consumer frustration.

### BRIEF SUMMARY

Embodiments of the present invention provide automatic tracking of inventory (e.g., consumable products) and re-ordering (such as automatically re-ordering or by notifying the user in some capacity) in an environment, such as a household. In this regard, various devices (e.g., manual dispensers, automated dispensers, various consumable product holders, spindles, storage devices, etc.) may be provided with one or more sensors configured to detect one or more characteristics regarding the consumable product. For example, in the case of tissue paper rolls and/or paper towel rolls, the tracked characteristic(s) may include: is the roll present, not present, has a dispensing roll been replaced, among other things. That information can be sent to a remote device (e.g., a smart hub, cloud server, etc. such as the wireless functionality, including WiFi) that determines whether or not a new order of the corresponding consumable product is needed. Though some of the description herein is focused on paper towel rolls and/or tissue paper rolls, some embodiments of the present invention contemplate usage with other types of household consumable products, such as fluid (e.g., hand soap, dishwashing liquid, fluids for wetted dispensers, air freshener, etc.), napkins, paper plates, bulk storage products, such as dog food or cereal, or other types of consumable products for the household environment.

In some embodiments, a user (e.g., a household member in charge of ordering replacement inventory) may utilize a software application (e.g., stored on their mobile device, smart appliance, other computing device, and/or available via the internet) to provide preferences and/or settings for facilitating tracking and ordering of the replacement inventory. In some embodiments, a user may select the type of notification and/or automatic ordering functionality that is preferred, which may depend on the type of inventory. For example, upon determining that replacement consumable product is needed, the user may receive a notification of such without any other prompting (e.g., a manual re-order function). Alternatively, a user may receive a notification with a link and/or option to select and initiate an order for replacement consumable product (e.g., a semi-automated re-order function). Further, in some cases, the system may just automatically initiate the re-order with or without notifying the user (e.g., an automated re-order function).

Embodiments of the present invention contemplate many different types of devices, such as dispensers, spindles, consumable product holders, and storage devices (among other devices), that can be used with example systems to perform the inventory tracking. In some embodiments, the system is configured to receive sensor data from various devices and, such as through various logic, determine the overall inventory of the household environment (which may or may not include consumable product stored separately from the one or more devices). For example, the system may take into account an original inventory (e.g., set by the user and/or determined over time) and sensor data from two or more devices. In some cases, the system may account for previously ordered consumable product, such as from a recent online order. Then, based on a running inventory count/total (e.g., decrementing as the devices indicate accordingly), the system may determine it is time to initiate re-order functionality (e.g., notify the user, initiate a semi or automated re-order, etc.).

In an example embodiment, a system for providing automatic tracking and re-order functionality for an environment is provided. The system comprises a first consumables device configured to hold a quantity or level of first consumables. The first consumables device comprises a first consumables sensor configured to determine occurrence of a change in the quantity or level of the first consumables within the first consumables device and a first consumables communication interface configured to transmit first sensor data of the first consumables sensor to a remote device. The system comprises a second consumables device configured to hold a quantity or level of second consumables. The second consumables are different than the first consumables. The second consumables device comprises a second consumables sensor configured to determine occurrence of a change in the quantity or level of the second consumables within the second consumables device and a second consumables communication interface configured to transmit second sensor data of the second consumables sensor to the remote device. The system further comprises the remote device comprising a processor configured to: receive the first sensor data and the second sensor data; determine a current inventory status corresponding to the quantity or level of the first consumables currently in the environment; and determine a current inventory status corresponding to the quantity or level of the second consumables currently in the environment. The processor is also configured to perform re-order functionality for the first consumables in an instance in which the current inventory status corresponds to a threshold re-order inventory status for the first consumables, wherein the re-order functionality comprises a semi-automated re-order function. The semi-automated re-order function corresponds to providing an option for a user to initiate the order to replenish the first consumables, wherein the option requires user interaction prior to initiating the order to replenish the first consumables. The processor is further configured to perform re-order functionality for the second consumables in an instance in which the current inventory status corresponds to a threshold re-order inventory status for the second consumables, wherein the re-order functionality comprises one of an automated re-order function, a semi-automated re-order function, or a manual re-order function. The automated re-order function corresponds to automatic initiation of an order to replenish the second consumables. The semi-automated re-order function corresponds to providing an option for a user to initiate the order to replenish the second consumables. The manual re-order function corresponds to providing a notification to the user that the current inventory status of the second consumables corresponds to threshold re-order inventory status of the second consumables so as to remind the user to replenish the second consumables.

In some embodiments, the system further comprises a software application installed on a user computing device. The remote device is configured to: transmit, in conjunction with the semi-automated re-order function for the first consumables, a notification to the software application providing the option, via the software application, to initiate the order to replenish the first consumables. In some embodiments, in conjunction with the semi-automated re-order function for the first consumables, the notification indicates that the current inventory status of the first consumables in the environment corresponds to the threshold re-order inventory status for the first consumables, and in conjunction with the semi-automated re-order function for the second consumables, the notification indicates that the current inventory status of the second consumables in the environment corresponds to the threshold re-order inventory status for the second consumables. In some embodiments, the software application enables the user to modify the re-order functionality for the first consumables to select one of an automated re-order function, the semi-automated re-order function, or the manual re-order function. In some embodiments, the remote device is configured to determine the current inventory status corresponding to the quantity or level of the first consumables currently in the environment based on the first sensor data and an estimated or inputted amount of extra first consumables stored within the environment. In some embodiments, the software application enables the user to input the amount of extra first consumables stored within the environment. In some embodiments, the remote device is configured to update the estimated or inputted amount of extra first consumables stored within the environment based on received shipments of replacement first consumables. In some embodiments, the remote device is further configured to update the amount of extra first consumables stored within the environment based on the occurrence of a change in the quantity or level of the first consumables within the first consumables device.

In some embodiments, the remote device is configured to determine the current inventory status corresponding to the quantity or level of the first consumables currently in the environment based on a plurality of first consumable devices within the environment. In some embodiments, the plurality of first consumable devices within the environment comprises at least one first type of first consumable device and at least one second type of first consumable device, wherein the first type of first consumable device and the second type of first consumable device comprise different types of sensors configured to sense first consumables. In some embodiments, the plurality of first consumable devices within the environment comprises at least one first type of first consumable device and at least one second type of first consumable device, wherein the first type of first consumable device is configured to store replacement first consumables, wherein the second type of first consumable device is configured to enable dispensing of first consumables.

In some embodiments, the occurrence of the change in the quantity or level of the first consumables corresponds to one of installation in or removal of a tissue paper roll from the first consumables device. In some embodiments, the second consumables are one of napkins or plates. In some embodiments, the second consumables are paper towel. In some embodiments, the second consumables are loose bulk storage products.

In some embodiments, the remote device comprises one of a remote server or a remote computing device positioned within the environment.

In some embodiments, corresponding methods and/or computer program product are provided.

In another example embodiment, a sheet product dispenser is provided. The sheet product dispenser includes a stand portion configured to hold at least one sheet product roll. The stand portion comprises at least one reserve position, wherein each sheet product roll stored on the stand portion is positioned in a corresponding reserve position. The stand portion further comprises at least one sensor, wherein each sensor is positioned relative to a corresponding reserve position and configured to sense the presence or absence of a sheet product roll in the corresponding reserve position. The sheet product dispenser further includes a dispense portion configured to hold a sheet product roll in a dispensing position that enables a user to obtain a dispense from the sheet product roll in the dispensing position. The sheet product dispenser further includes a communication interface configured to transmit sensor data to a remote device, wherein the sensor data is indicative of a number of sheet product rolls stored on the sheet product dispenser. In some embodiments, corresponding methods and systems are provided.

In yet another example embodiment, a spindle for enabling dispensing of a sheet product roll is provided. The spindle comprises a first body portion and a second body portion. The second body portion is sized and configured to be received in a telescoping manner by the first body portion to enable the spindle to extend and compress between a fully extended state and a fully compressed state. The spindle further includes at least one installation protrusion configured to mate with a spindle holder to enable installation of the spindle in the spindle holder such that the spindle defines an installed state, wherein the spindle is configured to define different widths in the installed state. The spindle further includes a first spring configured to bias the first body portion to extend away from the second body portion so as to bias the spindle to the fully extended state. The spindle further includes a sensor configured to sense at least one of when the spindle is in an installed state or when the spindle is in the fully extended state. The spindle further includes a second spring attached to the sensor and configured to bias the sensor toward a fully extended sensor position. The sensor is movable within at least one of the first body portion and the second body portion such that the sensor is configured to sense when the spindle is in the installed state over a range of widths of the spindle. The sensor is not configured to sense that the spindle is in the installed state when the spindle is in the fully extended state. The spindle further includes a communication interface configured to transmit sensor data to a remote device. In some embodiments, corresponding methods and systems are provided.

In yet another example embodiment, a sheet product dispenser is provided. The sheet product dispenser includes a stand portion configured to fit within an installed sheet product roll. The sheet product dispenser further includes a base portion extending radially outward from the stand portion. The base portion is configured to support the stand portion such that the stand portion extends vertically from the base portion. The base portion comprises a sensor configured to sense the installed sheet product roll. The sheet product further includes a communication interface configured to transmit sensor data to a remote device, wherein the sensor data indicates presence or absence of the installed sheet product roll. In some embodiments, corresponding methods and systems are provided.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a block diagram of an example tracking and re-order system, in accordance with some embodiments discussed herein;

FIG. 2 illustrates a block diagram of another example tracking and re-order system, in accordance with some embodiments discussed herein;

FIG. 3 illustrates a block diagram of an example device (e.g., tracking device, mobile device, smart hub, remote device), in accordance with some embodiments discussed herein;

FIG. 4 shows an example tissue paper dispenser for tissue paper rolls for use with various example tracking and re-order systems, in accordance with some embodiments discussed herein;

FIG. 5 shows the example tissue paper dispenser shown in FIG. 4, where the dispense portion has been rotated to an installation orientation, in accordance with some embodiments discussed herein;

FIG. 6 shows another example tissue paper dispenser for tissue paper rolls for use with various example tracking and re-order systems, where a top portion of the stand has been removed from a bottom portion of the stand to enable installation or removal of replacement tissue paper rolls on the stand, in accordance with some embodiments discussed herein;

FIG. 7 shows the example tissue paper dispenser shown in FIG. 6, where the top portion has been attached to the bottom portion and replacement tissue paper rolls are installed on the stand, in accordance with some embodiments discussed herein;

FIG. 8 shows an example tissue paper device that acts as a storage device for replacement tissue paper rolls, in accordance with some embodiments discussed herein;

FIG. 9 shows an example tissue spindle for tissue paper rolls for use with various example tracking and re-order systems, in accordance with some embodiments discussed herein;

FIG. 10A shows a cross-sectional view of an example tissue spindle for dispensing tissue paper for use with various example tracking and re-order systems, wherein the spindle is in the relaxed (e.g., fully extended) state, in accordance with some embodiments discussed herein;

FIG. 10B shows a cross-sectional view of the example tissue spindle shown in FIG. 10A, wherein the spindle has been partially compressed and is in an installed state, in accordance with some embodiments discussed herein;

FIG. 10C shows a cross-sectional view of the example tissue spindle shown in FIG. 10A, wherein the tissue spindle has been fully compressed and is in the installed state, in accordance with some embodiments discussed herein;

FIG. 11 shows an example tissue spindle with extender installation protrusions the enable use of an over-sized tissue paper roll in a recessed tissue paper roll holder, in accordance with some embodiments discussed herein;

FIG. 12A shows the example tissue spindle show in FIG. 11, where one of the extender installation protrusions is in the engaged position, in accordance with some embodiments discussed herein;

FIG. 12B shows the example tissue spindle show in FIG. 11, where one of the extender installation protrusions is in the disengaged position, in accordance with some embodiments discussed herein;

FIG. 13 shows example automated paper towel dispenser for use with various example tracking and re-order systems, in accordance with some embodiments discussed herein;

FIG. 14 shows an example paper towel holder for use with various example tracking and re-order systems, in accordance with some embodiments discussed herein;

FIG. 15 shows the example paper towel holder of FIG. 14 with an installed paper towel roll, in accordance with some embodiments discussed herein;

FIG. 16A shows an example paper towel dispenser for use with various example tracking and re-order systems, in accordance with some embodiments discussed herein;

FIG. 16B shows a close-up view of a portion of the example paper towel holder of FIG. 16A, with a paper towel roll installed, in accordance with some embodiments discussed herein;

FIG. 17 shows an example paper towel dispenser for use with various example tracking and re-order systems, in accordance with some embodiments discussed herein;

FIG. 18A shows a close-up view of another example paper towel dispenser for use with various example tracking and re-order systems, in accordance with some embodiments discussed herein;

FIG. 18B illustrates a top schematic view illustrating example positioning of two sensors on the base portion of the paper towel dispenser shown in FIG. 18A, in accordance with some embodiments discussed herein;

FIG. 19 illustrates an example paper towel dispenser, where a time-of-flight sensor is angled toward an installed paper towel roll, in accordance with some embodiments discussed herein;

FIG. 20 illustrates an example napkin holder for use with various example tracking and re-order systems, in accordance with some embodiments discussed herein;

FIG. 21 shows an exploded view of the napkin holder shown in FIG. 20, in accordance with some embodiments discussed herein;

FIG. 22 shows a cross-sectional view of the napkin holder shown in FIG. 20, wherein a supply of napkins extends above a sensor, in accordance with some embodiments discussed herein;

FIG. 23 shows a cross-sectional view of the napkin holder shown in FIG. 20, wherein the supply of napkins has been depleted below the sensor, in accordance with some embodiments discussed herein;

FIG. 24 illustrates an example paper plate holder for use with various example tracking and re-order systems, in accordance with some embodiments discussed herein;

FIG. 25 shows an exploded view of the paper plate holder shown in FIG. 24, in accordance with some embodiments discussed herein;

FIG. 26 shows a cross-sectional view of the paper plate holder shown in FIG. 24, wherein a supply of paper plates extends above a sensor, in accordance with some embodiments discussed herein;

FIG. 27 shows a cross-sectional view of the paper plate holder shown in FIG. 24, wherein the supply of paper plates has been depleted below the sensor, in accordance with some embodiments discussed herein;

FIG. 28 shows a bottom cross-sectional view of the paper plate holder shown in FIG. 24, where the guide plates are in a first position, enabling insertion of a larger-sized paper plate, in accordance with some embodiments discussed herein;

FIG. 29 shows a bottom cross-sectional view of the paper plate holder shown in FIG. 24, where the guide plates are in a second position, enabling insertion of a smaller-sized paper plate, in accordance with some embodiments discussed herein;

FIG. 30 shows a bottom perspective view of an example guide plate for the paper plate holder shown in FIG. 24, in accordance with some embodiments discussed herein;

FIG. 31 shows an example cam plate for the paper plate holder shown in FIG. 24, in accordance with some embodiments discussed herein;

FIG. 32 shows a top perspective view of an example guide plate for the paper plate holder shown in FIG. 24, in accordance with some embodiments discussed herein;

FIG. 33 shows an example base plate for the paper plate holder shown in FIG. 24, in accordance with some embodiments discussed herein;

FIG. 34 illustrates an exploded view of an example bulk storage product holder for use with various example tracking and re-order systems, in accordance with some embodiments discussed herein;

FIG. 35A shows a cross-sectional view of the bulk storage product holder shown in FIG. 34, wherein a supply of bulk storage product extends above a sensor, in accordance with some embodiments discussed herein;

FIG. 35B shows a cross-sectional view of the bulk storage product holder shown in FIG. 34, wherein the supply of bulk storage product has been depleted below the sensor, in accordance with some embodiments discussed herein;

FIG. 36 illustrates a top perspective view of another example bulk storage product holder for use with various example tracking and re-order systems, where a top of the lid is removed, in accordance with some embodiments discussed herein;

FIG. 37A shows a cross-sectional view of the bulk storage product holder shown in FIG. 36, wherein a supply of bulk storage product extends above a sensor, in accordance with some embodiments discussed herein;

FIG. 37B shows a cross-sectional view of the bulk storage product holder shown in FIG. 36, wherein the supply of bulk storage product has been depleted below the sensor, in accordance with some embodiments discussed herein;

FIG. 38A illustrates an example screen of a user interface that enables a user to connect a tracking device to the tracking and re-order system, in accordance with some embodiments discussed herein;

FIG. 38B illustrates an example screen of a user interface that enables a user to select a local network for connecting the tracking device to an external network, in accordance with some embodiments discussed herein;

FIG. 39A illustrates an example screen of a user interface that enables a user to enroll in a subscription service or other replenishment service for ordering new consumable product, in accordance with some embodiments discussed herein;

FIG. 39B illustrates an example screen of a user interface that enables a user to select a consumable product order option for use with the subscription service or other replenishment service, in accordance with some embodiments discussed herein;

FIG. 39C illustrates an example screen of a user interface that enables a user to select a battery order option for use with the subscription service or other replenishment service, in accordance with some embodiments discussed herein;

FIG. 40 illustrates an example screen of a user interface that enables a user to select settings corresponding to a tracking device that is part of the tracking and re-order system, in accordance with some embodiments discussed herein;

FIG. 41 illustrates an example screen of a user interface that provides a user with statuses of various tracking devices that are part of the tracking and re-order system, in accordance with some embodiments discussed herein;

FIG. 42A illustrates an example screen of a user interface that enables a user to set the threshold for a household inventory that corresponds to when to initiate re-order functionality utilizing the tracking and re-order system, in accordance with some embodiments discussed herein;

FIG. 42B illustrates an example screen of a user interface that enables a user to set an extra inventory level, select whether or not to enable automatic ordering, and set the threshold for a household inventory that corresponds to when to initiate re-order functionality utilizing the tracking and re-order system, in accordance with some embodiments discussed herein;

FIG. 43 illustrates an example screen of a user interface that enables a user to place an order for more consumable product, such as may be provided to the user in response to a household inventory threshold being met, in accordance with some embodiments discussed herein;

FIG. 44 illustrates an example screen of a user interface that provides information regarding current inventory and battery level for the tracking and re-order system, along with the option to order more of each, in accordance with some embodiments discussed herein;

FIG. 45 illustrates an example screen of a user interface that shows recent orders that have been placed for the tracking and re-order system, in accordance with some embodiments discussed herein;

FIG. 46 illustrates an example screen of a user interface that shows a general system level view of a user's inventory tracking and re-order system, in accordance with some embodiments discussed herein;

FIG. 47 illustrates an example screen of a user interface that shows a detail view of a device used in an inventory tracking and re-order system, in accordance with some embodiments discussed herein;

FIG. 48 illustrates an example screen of a user interface that enables a user to adjust settings for the tracking and re-order system, in accordance with some embodiments discussed herein;

FIG. 49 illustrates an example screen of a user interface that enables a user to adjust a setting regarding when the inventory of the consumable product is considered low for initiating re-order functionality, in accordance with some embodiments discussed herein;

FIG. 50 illustrates an example screen of a user interface that enables a user to set the desired re-order functionality for when the inventory is considered low, in accordance with some embodiments discussed herein;

FIG. 51 illustrates an example screen of a user interface that enables a user to adjust settings for the tracking and re-order system, where a subscription service is enabled, in accordance with some embodiments discussed herein;

FIG. 52 illustrates an example screen of a user interface that shows details regarding the enrolled subscription service, in accordance with some embodiments discussed herein; and

FIG. 53 illustrates a flowchart according to an example method for providing automatic tracking and re-order functionality, in accordance with some embodiments discussed herein.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout.

As used herein, the term “consumable” or “consumable product” may be any type of product that is capable of being used up/depleted and replaced. Some example consumable products contemplated herein include sheet product, such as tissue paper rolls and paper towel rolls, napkins, paper plates, bulk storage products, such as dog food or cereal, fluid product, such as soap or air freshener, among other things.

As used herein, the term “sheet product” may include a product that is relatively thin in comparison to its length and width. Further, the sheet product may define a relatively flat, planar configuration. In some embodiments, the sheet product is flexible or bendable to permit, for example, folding, rolling, stacking, or the like. In this regard, sheet product may, in some cases, be formed into stacks or rolls for use with various embodiments described herein. Some example sheet products include towel, bath tissue, facial tissue, napkin, wipe, wrapping paper, aluminum foil, wax paper, plastic wrap, or other sheet-like products. Sheet products may be made from paper, cloth, non-woven, metallic, polymer or other materials, and in some cases may include multiple layers or plies. In some embodiments, the sheet product (such as in roll or stacked form) may be a continuous sheet that is severable or separable into individual sheets using, for example, a tear bar or cutting blade. Additionally or alternatively, the sheet product may include predefined areas of weakness, such as lines of perforations, that define individual sheets and facilitate separation and/or tearing. In some such embodiments, the lines of perforations may extend along the width of the sheet product to define individual sheets that can be torn off by a user.

As used herein, a “user” may be a maintainer (e.g., an orderer, a maintenance person or inventory/device manager, etc.) or a consumer (e.g., a person receiving the consumable product).

### Example Tracking and Re-Order System

Consumers today are faced with endless tasks to upkeep their home and current solutions are not meeting their needs. Keeping accurate inventory of household consumable products, such as sheet product like tissue paper and paper towel, may be a major pain point because the consumable product is constantly in need of restocking and it can be a pain to obtain the consumable product from the store. Many consumers have turned to subscription models for their consumable products but have been let down because they are now subject to over/under stocking and price/product changes (or even a skipped delivery) without adequate warning or control.

Some embodiments of the present invention provide automatic tracking of inventory (e.g., consumable product) and re-ordering (such as automatically re-ordering or by notifying the user in some capacity) in an environment, such as a household. Notably, while some example embodiments are described herein with respect to a household environment, any sort of environment is contemplated, such as an office building, office space, commercial space, multiple homes, etc. In this regard, maintaining track of item inventory within an environment can be difficult or timing consuming. Thus, example tracking and re-order systems provided herein utilize various devices and sensors with remote logic to provide automatic tracking and re-order functionality for households.

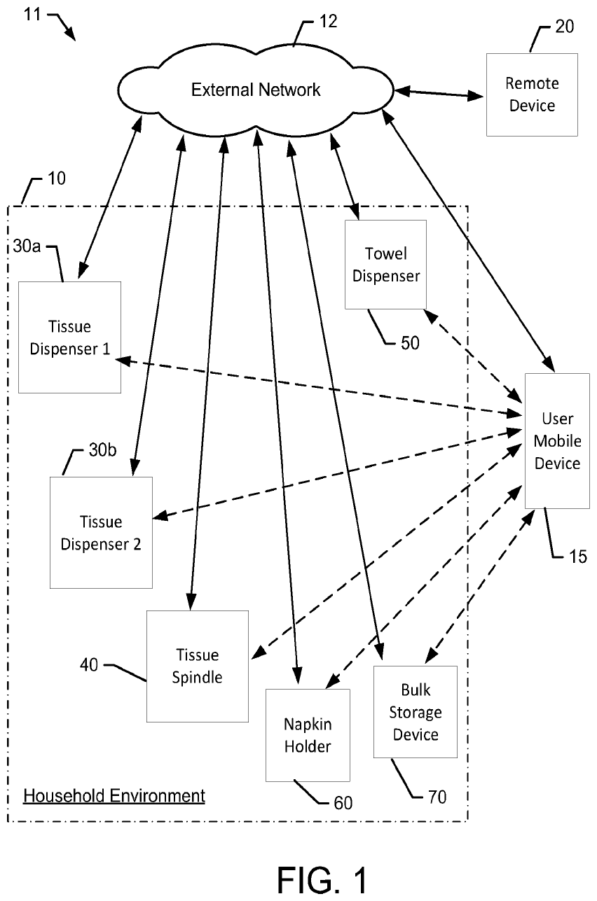

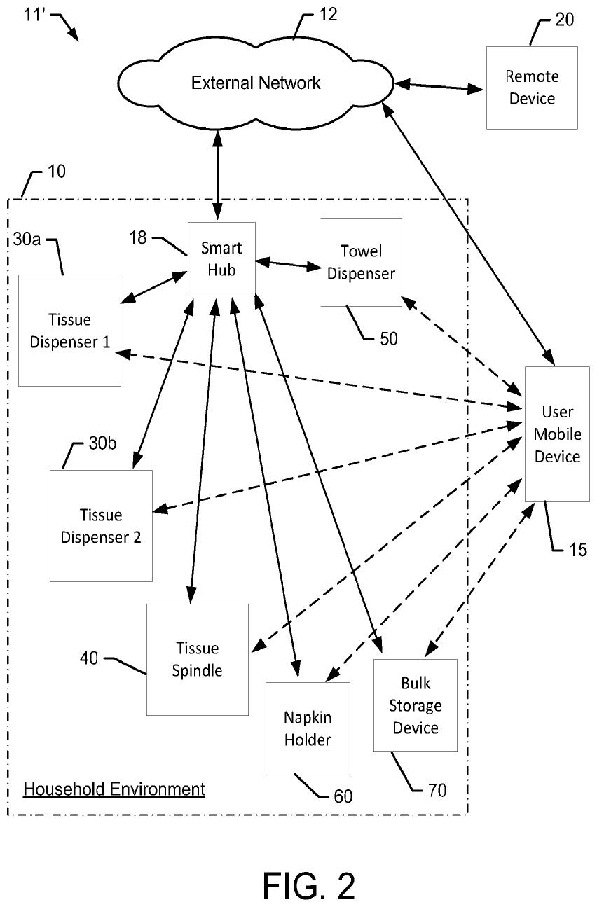

FIGS. 1 and 2 illustrate example tracking and re-order functionality systems 11, 11′ contemplated by various embodiments of the present invention.

In this regard, various devices (e.g., manual dispensers, automated dispensers, holders, bulk storage devices, spindles, storage devices, etc.) may be provided with one or more sensors configured to detect one or more characteristics regarding a consumable product. For example, some example systems provide a suite of devices that can be purchased and utilized with the example systems to provide for automatic tracking and re-order functionality.

In some embodiments, the system 11, 11′ is configured to receive sensor data from various devices within the household environment 10. For example, the system 11, 11′ may be utilized with one or more tracking devices that are configured to track usage of one or more types of consumable products (and may include providing tracking and/or re-order functionality for multiple different consumable products at the same time in the same household environment). As an example, FIG. 1 illustrates a household environment 10 that includes two tissue dispensers 30a, 30, a tissue spindle 40, a paper towel dispenser 50, a napkin holder 60, and a bulk storage device 70 (although any number of consumable product devices are contemplated and any number of types of consumable products being tracked are contemplated). Additional detail regarding various contemplated devices is provided herein.

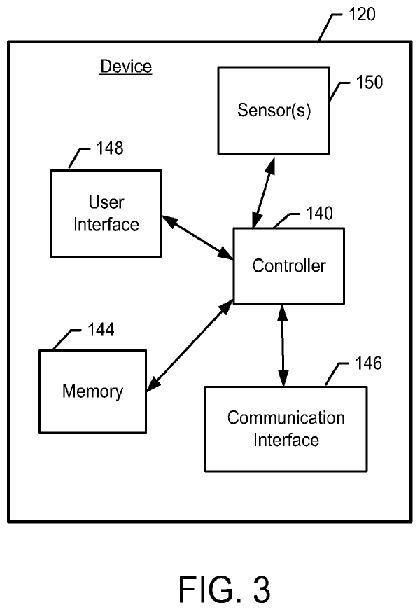

FIGS. 1-2 illustrate example communication ability between the various tracking devices of example automatic tracking and re-order systems described herein. For example, one or more tracking devices may be positioned throughout a household 10 (although other environments are also contemplated—such as offices, facilities, stadiums, etc.). Each device may be configured with one or more communication interfaces and may transmit/receive data with respect to at least one of a user mobile device (such as through a software application) and a remote device through an external network (e.g., a cloud server). In some embodiments, with reference to FIG. 2, one or more smart hubs 18 may be positioned within the household environment 10 such that the tracking devices may be configured to communicate with the smart hub 18 to enable operation of the system. In some embodiments, one or more of the tracking devices may be configured as a smart hub 18. Further, though not shown, the devices may be configured to communicate directly with each other. In this regard, different wireless or wired communication protocols may be used (e.g., Z-Wave, Zigbee, WiFi, Bluetooth, cellular, etc.) for embodiments of the present invention. In this regard, various functionality of the example embodiments described herein may be performed at one or more of the tracking devices, smart hub 18, remote device 20, and/or mobile device 15. In this regard, the tracking devices, smart hub 18, remote device 20, and/or mobile device 15 may include appropriate components, such as a controller, memory, communication interface, user interface, etc., configured to perform the various functionality (such as further described with respect to FIG. 3).

The system 11, 11′ may be configured to receive sensor data from the various tracking devices and, such as through various logic, determine the overall inventory of the household environment (which may or may not include consumable product stored separately from the one or more devices). For example, the system 11, 11′ may take into account an original inventory (e.g., set by the user and/or determined over time) and sensor data from two or more devices. That information can be sent to a remote device (e.g., a smart hub 18 within the household environment 10 (shown in FIG. 2), a remote device 20, such as a cloud server (shown in FIG. 1), etc.) that uses logic and algorithms to determine whether or not a new order of the corresponding consumable product is needed. Then, based on a running inventory total (e.g., decrementing as the devices indicate accordingly), the system may determine it is time to initiate re-order functions (e.g., notify the user, initiate a semi or automated re-order, etc.). In some cases, the system may account for previously ordered consumable product, such as from a recent online order.

In some embodiments, the system 11, 11′ may be configured to determine that it is time to initiate re-order functionality in various manners. Various example logic/algorithms for use in determining when to initiate re-order functionality are described herein. For example, the system may determine that it is time to initiate re-order functionality in response to determining that an inventory count for the household environment 10 has reached and/or passed a certain re-order threshold. In some embodiments, the re-order threshold may be based on a user preference. In some embodiments, the re-order threshold may be based on one or more factors, such as available re-order options, estimated delivery time, user preferences, user order history, a certain amount of time passing, etc.

### Example Device Architecture

As detailed herein, various functionality may be performed according to the systems 11, 11′ via one or more of the tracking devices, smart hub 18, remote device 20, and/or mobile device 15. FIG. 3 illustrates example components of such devices that may be utilized with various functionality described herein. For example, FIG. 3 shows a device 120 with a controller 140, memory 144, communication interface 146, a user interface 148, and one or more sensor(s) 150. Notably, depending on the desired device, more or less components may be utilized. For example, a tracking device may include one or more sensors (such as described herein), and may not include a user interface 148. Likewise, the remote device may not include one or more sensor(s) 150.

The controller 140 may be any means configured to execute various programmed operations or instructions stored in a memory device such as a device or circuitry operating in accordance with software or otherwise embodied in hardware or a combination of hardware and software, thereby configuring the device or circuitry to perform the corresponding functions of the controller 140 as described herein

The controller 140 may comprise one or more suitable electronic device(s)/server(s) capable of executing described functionality via hardware and/or software control. In some embodiments, the controller 140 may include one or more user interfaces (not shown), such as for displaying information and/or accepting instructions. The controller 140 can be, but is not limited to, a microprocessor, microcomputer, a minicomputer, an optical computer, a board computer, a complex instruction set computer, an ASIC (application specific integrated circuit), a reduced instruction set computer, an analog computer, a digital computer, a molecular computer, a quantum computer, a cellular computer, a solid-state computer, a single-board computer, a buffered computer, a computer network, a desktop computer, a laptop computer, a personal digital assistant (PDA) or a hybrid of any of the foregoing.

The controller 140 may include one or more processors coupled to a memory device (e.g., memory 144). Controller 140 may optionally be connected to one or more input/output (I/O) controllers or data interface devices (not shown). The memory 144 may be any suitable form of memory such as an EPROM (Erasable Programmable Read Only Memory) chip, a flash memory chip, a disk drive, or the like. As such, the memory 144 may store various data, protocols, instructions, computer program code, operational parameters, etc. In this regard, controller may include operation control methods embodied in application code. These methods are embodied in computer instructions written to be executed by one or more processors, typically in the form of software. The software can be encoded in any suitable language, including, but not limited to, machine language, assembly language, VHDL (Verilog Hardware Description Language), VHSIC HDL (Very High Speed IC Hardware Description Language), Fortran (formula translation), C, C++, Visual C++, Java, ALGOL (algorithmic language), BASIC (beginners all-purpose symbolic instruction code), visual BASIC, ActiveX, HTML (HyperText Markup Language), and any combination or derivative of at least one of the foregoing. Additionally, an operator can use an existing software application such as a spreadsheet or database and correlate various cells with the variables enumerated in the algorithms. Furthermore, the software can be independent of other software or dependent upon other software, such as in the form of integrated software. In this regard, in some embodiments, the controller 140 may be configured to execute computer program code instructions to perform aspects of various embodiments of the present invention described herein.

The memory 144 may be configured to store instructions, computer program code, sensor data, inventory data, subscription data, online order data, and other data/information associated with the system 11, 11′ in a non-transitory computer readable medium for use, such as by the controller 140.

The communication interface 146 may be configured to enable connection to external systems (e.g., an external network, one or more tracking devices, mobile device(s), a computer server, the controller(s), and/or one or more other system(s)/device(s)). In some embodiments, the communication interface 146 may comprise one or more transmitters configured to transmit, for example, one or more signals according to example embodiments described herein. Likewise, the communication interface 146 may include at least one receiver configured to, for example, receive data according to example embodiments described herein. In some embodiments, the transmitter and receiver may be combined as a transceiver. In this regard, the food request system may be configured for wired and/or wireless communication. In some embodiments, the communication interface 146 may comprise wireless capabilities for WiFi, Bluetooth, or other wireless protocols.

The user interface 148 may be configured to receive input from a user and/or provide output to a user. The user interface 148 may include, for example, a display, a keyboard, keypad, function keys, mouse, scrolling device, input/output ports, touch screen, or any other mechanism by which a user may interface with the system. Although the user interface 148 is shown as being directly connected to the controller 140 and within the device 120, the user interface 148 could alternatively be remote from the controller 140 and/or device 120. Likewise, in some embodiments, other components of the device 120 could be remotely located.

The one or more sensors 150 may be any type of sensor configured to enable detection of one or more characteristics of consumable product in relation to one or more tracking devices, such as described herein. In some embodiments, multiple sensors and different types of sensors may be utilized in the same tracking device. Some example sensors include, for example, time-of-flight sensors, infrared sensors, optical sensors, weight-based sensors, capacitance sensors, mechanical switch type sensors, radar sensors, ultrasonic sensors, laser-based sensors, cameras, among many others. In this regard, various sensor(s) described herein may be configured with appropriate hardware to enable the corresponding desired sensing. For example, the sensor may comprise one or more transmitters and one or more receivers such as for transmitting a signal and receiving a reflected signal accordingly (e.g., for a time-of-flight sensor (which may also include a time component), infrared sensor, etc.). In some embodiments, the sensor may include a receiver for receiving/detecting an intensity of a received signal, such as for an optical sensor or infrared sensor.

In some embodiments, other features may be provided, such as a “push to reorder” button. For example, the device may include a button (or other user input) thereon that enables a user to simply provide the appropriate user input, which will send a signal to a remote device to cause initiation of a re-order for the correlated consumable product.

### Example System Functionality

As described herein, various example devices of the system monitor consumable product usage (e.g., tissue or towel roll replacement, amount of product used, etc.). Then, based on various user preferences in a software application, the system may be configured to determine when to initiate re-order functionality. Finally, the re-order occurs and delivery is scheduled and achieved. Example logic/algorithms and re-order functionality are described in greater detail herein.

In some embodiments, a user (e.g., a household member in charge of ordering replacement inventory) may utilize a software application (e.g., stored on their mobile device) to provide preferences and/or settings for facilitating tracking and ordering of the replacement inventory. In this regard, a user may indicate various preferences, such as the type/amount of consumable product (e.g., the type/amount of tissue paper roll and/or paper towel roll), preferred ordering method(s) (e.g., shipping details, a preferred ordering website, shipping address, billing specifics, etc.), pricing preferences and/or guidelines, a preferred amount of consumable product (e.g., number of replacement rolls) to have on hand, the user's WiFi code and password for the device(s) to use, what the standard re-order is (e.g., brand, amount (4-pack, 12-pack, etc.)), when to re-order or trigger a notification to re-order (e.g., when only 1 reserve tissue or towel roll remains), among other things.

In some embodiments, a user may select the type of notification and/or automatic re-order functionality that is preferred, which may depend on the type of inventory being tracked (e.g., different re-order functionality may be selected for different consumable products being tracked). For example, upon determining that replacement consumable product is needed, the user may receive a notification of such without any other prompting (e.g., a manual re-order function). Alternatively, a user may receive a notification with a link and/or option to select and initiate an order for replacement consumable product (e.g., a semi-automated re-order function). Further, in some cases, the system may just automatically initiate the re-order with or without notify the user (e.g., an automated re-order function). Further detail regarding example re-order functionality is described in greater detail herein.

In some embodiments, other types of notifications are also contemplated, such as notifying the user any time replacement of a consumable product occurs, such as when a tissue or towel roll is changed and/or used. In some embodiments, the user may be given an option as to whether to decrement an overall inventory, so as to help maintain an accurate overall inventory count (e.g., the triggered event may not be an event that should result in decrementing the overall inventory, such as the user just removing and reinstalling the same tissue or towel roll). Various embodiments of the present invention contemplate any type of notification to a user, such as a text message, instant message within the software application, email, call, stored message, audible alert, visual indication, etc., which may occur on the device or a remote device (e.g., the user's mobile device, a smart hub in the household, other computing device, etc.). Some additional notifications are detailed herein, such as with respect to the example software application.

Contemplated example systems may provide various beneficial functions/features. For example, the various tracking devices may be tested and provide reliable technology to help ensure accurate and seamless use; the software application (such as described further herein) may enable entry of customized user preferences; a user can lock in their price and duration for the re-ordered product; a user can select which retailer to use for the re-ordering; and the system can automatically search through a listing of pre-approved retailers for a best price to ensure that the lowest cost option is utilized with the re-order.

### Example Re-Order Functionality

In some embodiments, the system may be configured to operate according to various re-order functionality. For example, once a re-order trigger occurs (e.g., there is only a certain amount of consumable product (e.g., inventory) remaining), re-order functionality may occur according to one of the following preferences:

Manual: At the re-order trigger, a user may receive a notification (e.g. text, email, application push notifications, etc.) that they should purchase the replacement product by initiating a re-order. The user is then responsible to fulfill the order however they wish to.

Semi-Automatic: At the re-order trigger, a user may receive a notification to initiate, confirm, or cancel a pre-set re-order to purchase the replacement product. If they confirm the re-order, the system will generate an order for their preferred product to be delivered to their preferred address.

Automatic: At the re-order trigger, the system may automatically generate an order for the preferred product to be delivered to the user's preferred address, with no interaction required of the user. A notification may or may not occur. If a notification does occur, it may occur after the order is placed.

### Example Logic for Re-Order Triggering

Notably, there are many different factors for the logic/algorithms that could be used to cause a re-order trigger. The following provides some example logic/algorithm factors for tissue paper and paper towel roll replacement.

Example Reorder Logic 1, Household Consumable Product Remaining: User chooses a specific level of consumable product remaining for their combined household. For example, a user has 3 tissue stands, capable of tracking up to 12 tissue rolls combined. They can configure a combined household level of between 0-11 rolls remaining to trigger the reorder. The individual devices report their corresponding number of rolls, and the system counts those rolls to determine when to trigger re-order functionality.

Example Reorder Logic 2, Device Consumable Product Remaining: User chooses a specific level of consumable product remaining for each device in their household. For example, each device could be configured for between 0-3 rolls remaining to trigger the reorder. The delivery could then be associated with a specific device, or bathroom, in the household. The device itself could issue the reorder trigger because it needs no knowledge of other devices in the household.

Example Reorder Logic 3, Space Remaining: Rather than tracking consumable product remaining, the number of empty slots available for storage (e.g., in a storage device) is tracked. When there are enough storage slots to accommodate a preferred reorder, the reorder is triggered. For example, a household has 4 tissue stands (16 available slots), and has configured a 12 pack of rolls as their preferred reorder. When there are 12 empty slots available on the combined 4 tissue stands, the order is triggered. An alternative is that the order could be triggered at a threshold slightly below the reorder size. For the example above, since the user has 4 tissue stands and each tissue stand also has a roll in use that is not being tracked, the roll in use could also be considered a storage slot (e.g., 16 tracked slots, and 4 “roll in use” untracked slots for 20 storage slots total). So the system could trigger the reorder of a 12 pack when there are between 8-12 or more slots available with the assumption that some of the rolls in use will need to be replaced when the order arrives.

Example Reorder Logic 4, Inventory Management: In this logic example, a household inventory is managed. The user would establish the current household inventory, and the threshold of that inventory that would trigger a reorder (and/or base the trigger on preferred product, i.e. I prefer 12 packs of tissue rolls, and keep my household inventory between 8 and 32 rolls, so at 7 rolls remaining inventory, an order of 2, 12 packs occurs). The device would then track consumption of the inventory to decrement it, and the system would trigger the reorder, and increment the household inventory based on the reorder quantity. There could also be a means for the user to adjust their household inventory themselves (such as via a software application, such as described herein).

Example Reorder Logic 5, Predictive Reorder: For this logic example, the system may be configured to predict when to generate a reorder based on monitoring consumption and reorder trends over time for a particular user. Machine learning algorithms can be used where a user can be in manual or semi-auto mode for a training period and the system then switches them to fully automated based on learning the specifics of when a user confirms or cancels an order notification during the training period. This system could adapt over time to refine the accuracy of keeping the users inventory at optimum level by adjusting the reorder frequency to minimize manual requests for product reorder (e.g., user detected their inventory is too low) and to also minimize auto reorders from being cancelled by the user (e.g., user detected that a reorder would make their inventory too high).

Example Reorder Logic 6, Consumption Based: For this logic example, the system tracks consumption of the consumable products, and indicates to the remote device when a quantity of product is consumed. The remote device can then reorder product based on a set level of consumption. The user may have the option of choosing an arbitrary reorder level (e.g. reorder every X consumable product consumed), or the system may choose an arbitrary reorder level based on the product specified for reorder (e.g. if a user chooses a 12 pack of consumable product as their preferred reorder, the system could generate a reorder when it sees consumption of 9 consumable products, giving a buffer of three consumable products remaining). These two logic flows could also be combined where the user chooses the “product remaining” value (e.g. Reorder quantity is 12 consumable products, user chooses “2 Product Remaining” so that the remote device will reorder after 12−2=10 consumable product consumed).

Example Reorder Logic 7, Always Have a Spare: For this logic example, the consumable products may be sold in bundles of discrete refills where there would be at least 2 refills in what is reordered, and the tracking and reorder system may know the number of refills in the reorder. For example, a device that is a liquid soap dispenser that is refilled with a new bottle of liquid soap by the user when the bottle in use becomes empty may have sensors to detect when the user changes the bottle. In addition, the refill for such a device may be a 2 bottle pack. The device itself could come with a refill pack so that a known starting inventory of 2 can be assumed by the device. The reorder trigger may then ensure the user always has a spare bottle on hand to change out when the current bottle becomes empty, or said another way the trigger may occur when the last remaining spare is placed into the device. So for this example, the user places one of the 2 starting bottles in the device and begins using it. When the device detects that the user swaps to the 2nd bottle, it may trigger a reorder. Since it knows that the refill pack has two bottles, the subsequent reorder trigger may wait for 2 bottle changes to occur and then reorder the next 2-pack refill, and so on. The logic example could be extended to refill packs that have more than two by using, for example, the general rule: Trigger reorder after RefillSize−1 consumption events for the first refill order, and then after every RefillSize consumption events thereafter. This logic example may be useful for types of products that have a low consumption rate (e.g., the user is not likely to consume their last spare before the reorder arrives) and where a spare refill pack is small and easily stored with or near the device. In some embodiments of the logic example, the tracking and reorder system may be configured to enable device specific tracking as opposed to tracking household inventory, such that each device may trigger reorder functionality.

### Additional Example System Functionality

Various example tracking and reorder system described herein may provide further features/functionality.

In some embodiments, when a user has multiple tracking devices for the same consumable product type, the system may be configured to inform the user how to distribute the received consumable product their multiple tracking devices. This can be done based on each tracking device's available capacity and/or based on consumption history. The basis of such example logic may be to help a user distribute the consumable product in their house when they receive a new product order, so they don't have the burden of redistributing it later if they put more or less than needed at a single location. For example, a user has 3 tissue stands in their household. Tissue Stand 1 has 3 open slots, Tissue Stand 2 has 2 open slots, and Tissue Stand 3 has 1 open slot. Based on historical data for this user, the system may determine that on average each tissue stand will consume the following amounts before it is time to kick off the next reorder: Tissue Stand 1: 2 rolls, Tissue Stand 2: 4 rolls, and Tissue Stand 3: 6 rolls. Upon receiving their 12 pack of tissue when in this state, the algorithm could tell the user to distribute these rolls to ensure each stand will not run out prior to the next reorder as follows: Tissue 1 gets 3 new rolls since it has space for them. Tissue 2 gets 2 rolls to fill the device, and user is told to put an additional roll in that bathroom as a spare. Tissue 3 gets 1 new roll to fill it, and user is told to put at least 3 additional rolls in that room as spares. The user then can distribute the remaining 2 rolls as they see fit. In such a regard, in some embodiments, the logic example helps prevent running out of consumable product on an individual tracking device between replenishment cycles, thus avoiding the need for the user to redistribute their spare product in their household.

In some embodiments, the system may be configured to aggregate products that are being tracked. In this regard, a user may have multiple tracking devices monitoring and replenishing consumable products in their household environment or business. In this case, the user may wish to aggregate product re-ordering, for example to reduce shipping costs or various inconveniences associated with multiple orders. In such an example embodiment, the system may be configured to aggregate all two or more auto-replenishment orders and release the orders according to logic. In an example embodiment, the logic may be specified by the user. For example, the user may specify critical consumable product for which the order should be fulfilled immediately, and the user may specify non-critical consumable product for which the order may be delayed. For example, the user may specify that tissue paper is a critical consumable product that must be fulfilled immediately upon the order trigger, whereas paper towels and napkins are non-critical consumable products that should wait to be fulfilled the next time a critical consumable product is ordered. In another example embodiment, the user may specify that the non-critical consumable product should be fulfilled after a maximum elapsed time (e.g., 3 days) if no critical consumable products have been ordered during that time. In another example embodiment, the system may automatically or have pre-set one or more of these parameters, such as elevating a consumable product to critical status, aggregating and fulfilling orders before the maximum elapsed time, etc.

In some embodiments, the system may be configured to integrate the tracked consumable product orders with orders for non-tracked products. In this regard, as an example, a user may wish to have additional product replenished in the same order as products that are monitored by tracking device(s) and automatically replenished, for example to reduce shipping costs or various inconveniences associated with multiple orders. In an example embodiment, the system may allow the user to include additional items in the next order. For example, a user might wish to purchase a toaster or a pair of shoes. The system may be configured to allow that user to select those items (e.g., a toaster and a pair of shoes) and place them into a virtual shopping cart so that those items will be purchased and fulfilled for the user the next time the auto-replenished consumable products are ordered.

### Example Tracking Devices

Some embodiments of the present invention contemplate many different types of tracking devices, such as dispensers, spindles, holders, and storage devices (among other devices) that can be used with example systems to perform the inventory tracking. Such devices may include various sensors for tracking usage of the household consumable products (e.g., paper towel rolls, tissue paper rolls, napkins, paper plates, bulk storage products, soap, air freshener, batteries, other “wear” materials, etc.) as well as wireless and/or wired communication interfaces that enable transmitting the sensed data to a remote computing device for use in the system. In this regard, various types of devices are contemplated for use with various embodiments described herein.

Notably, in some embodiments, any such tracking devices may be paired to a software application, such as for a mobile device. The tracking devices may communicate with each other, the mobile device, a smart hub for the household, and/or to a remote device (e.g., cloud server) such as described with respect to FIGS. 1-2.

### Example Tissue Dispensers/Stands

Example tissue paper storage devices/dispensers (e.g., stands, bins, baskets, etc.) may include one or more sensors that are configured to determine how many rolls are stored therein and/or when a roll is removed (such as for replacement/usage). Although the following is described in conjunction with tissue rolls, some embodiments contemplate the same or similar features/functions with respect to other sheet product rolls (such as paper towel rolls, napkin rolls, etc.).

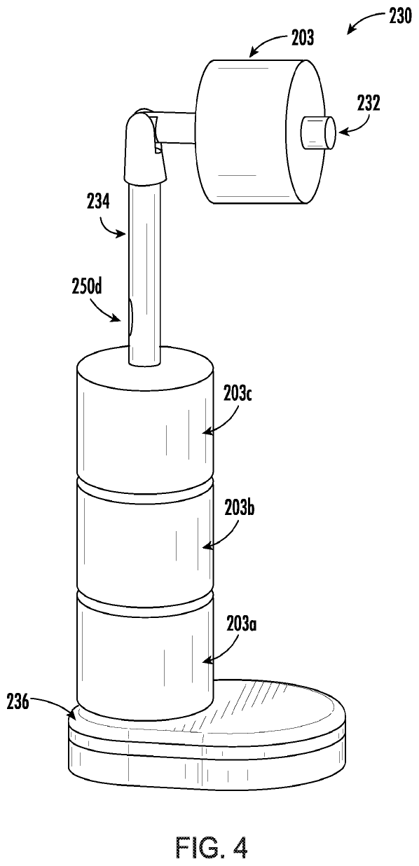

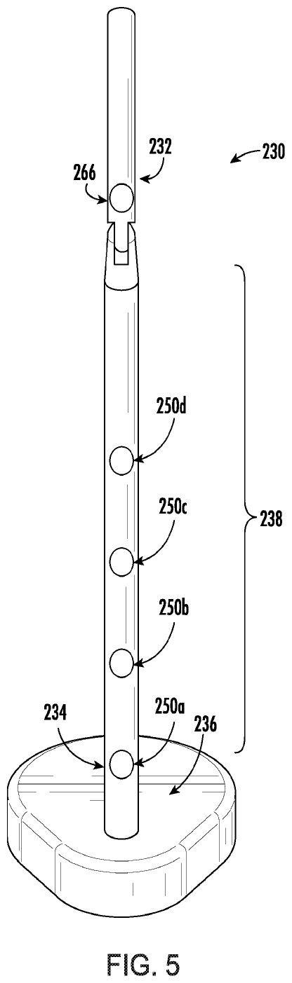

FIGS. 4-5 illustrate an example manual tissue paper dispenser 230 (e.g., a tissue roll dispense portion 232 and a stand portion 234) for use with example systems described herein. The dispense portion 232 may be configured to hold a tissue paper roll in a dispensing position/configuration that allows a user to receive a dispense of the tissue paper (e.g., pull off one or more pieces of tissue paper). Additionally, the stand portion 234 may store one or more replacement tissue paper rolls. The tissue holder and/or tissue stand may include one or more sensors that track usage of the tissue paper rolls. For example, the holder may include a sensor that senses when a replacement tissue paper roll has been put on the holder—thereby enabling a decrement to the overall inventory. Additionally, the tissue dispenser may include a communication interface capable of transmitting the sensed data to a remote device. In some embodiments, the dispense portion 232 may be removed and the tissue paper dispenser 230 may be utilized as a storage device only (e.g., with the stand portion 234 remaining).

The example of FIGS. 4 and 5 illustrate a tissue dispenser 230 with a dispense portion 232, a stand portion 234, and a base portion 236. The dispense portion 232 is configured to hold a tissue roll 203 during dispensing (e.g., the tissue roll 203 may rotate thereon and enable a user to pull off one or more sections for dispensing). The stand portion 234 may be an elongated portion configured to hold replacement rolls (e.g., reserve rolls 203a, 203b, 203c). For example, the stand portion 234 may define a diameter sized to fit within a central opening of a tissue roll such that the stand portion fits within each tissue roll stored thereon. Further, as illustrated, the stand portion 234 may be designed such that multiple tissue rolls may be arranged in a stacked formation on top of each other (e.g., the side surfaces of adjacent tissue rolls may touch each other and tissue rolls may support each other—such as shown in FIG. 4).

The stand portion 234 may include multiple sensors (e.g., sensors 250a, 250b, 250c, 250d—as shown in FIG. 5), where each sensor is positioned along the stand portion 234 at an appropriate position to facilitate sensing the presence or absence of a specific reserve roll (e.g., 4 sensors for 4 reserve roll positions). The base portion 236 is configured to hold the stand portion 234 and the dispense portion 232. The base portion 236 may house circuitry that is used to monitor the amount of replacement rolls on the stand portion 234. Additionally, the base portion 236 may include a communication interface that facilitates communication with a remote device (e.g., the cloud/internet), a user's mobile device (such as through a software application on the user's mobile device), a smart hub, and/or other tracking devices. In such a regard, the dispenser 230 may be able to determine how many replacement rolls are stored thereon and communicate that information to the system for determining and performing re-order functionality accordingly. In some embodiments, the dispenser 230 may determine and perform the re-order functionality itself.

In some embodiments, the sensors 250 may be configured as any type of sensor, such as an optical or time-of-flight sensor to sense whether a reserve roll is present. Additionally, however, other ways of monitoring the amount of replacement rolls in the dispenser are also contemplated. For example, the base portion 236 may include a weight sensor that senses the weight applied to the base portion, where more weight may indicate that more rolls are stored thereon.

In some embodiments, a user may be able to slide a reserve tissue roll from its reserve position on the stand portion 234 into the dispensing position on the dispense portion 232. For example, the dispense portion 232 may be configured to rotate or otherwise move/change positions between a dispensing orientation (shown in FIG. 4) into an installation orientation (shown in FIG. 5). Further, at least a portion of the dispense portion 232 may define a diameter sized to fit within the central opening of a tissue roll and there may be a corresponding path 238 between the portion of the stand portion 234 with the diameter sized to fit within the central opening of a tissue roll and the portion of the dispense portion with the diameter sized to fit within the central opening of a tissue roll. In this regard, the path 238 may define a diameter sized to fit within the central opening of a tissue roll such that a sheet product roll stored on the stand portion 234 can be moved along the path 238 to the dispense portion 232. This would enable a user to slide a reserve roll into the dispensing position when the dispense portion 232 is in the installation orientation.

In some embodiments, a wake-up sensor 266 may be used to trigger powering on of the sensors, transmission of information, and/or re-order checking functionality. To explain, in some cases, if the logic for determining whether to re-order replacement rolls is always functioning, that could be a significant power drain on the batteries. Thus, in some embodiments, a wake-up sensor 266 may be positioned in the dispenser 230 to cause the device to wake-up and check if re-order functionality is needed. Thus, the power drain would be reduced. An example wake-up sensor includes a light sensor (e.g., for sensing when the bathroom lights turn on). Another example wake-up sensor 266 may be positioned to determine when rotation of the dispense portion 232 occurs, such that the sensors are only checked when a reserve roll is theoretically moved to the dispensing position.

In some example embodiments, wake-up functionality can be initiated, such as on-demand or at various set points (e.g., during the commissioning process (described more herein)). For example, when a tracking device is first commissioned for use with the tracking and reorder system, instructions could be sent to the tracking device to check the amount of product stored thereon. In some embodiments, the frequency of product checking (e.g., utilizing wake-up functionality) may be increased, as users are more interested in confirming that the tracking device is operating properly during the commissioning process. In some embodiments, a wake-up instruction could be sent when it is determined that the user is utilizing the software application (described in more detail herein) and proximate the tracking device. In some embodiments, the tracking device may connect directly (e.g., wirelessly) to the user device to provide an update to the software application for the amount of product stored therein (e.g., instead of providing the data through an external network—which may delay such reporting to the user).

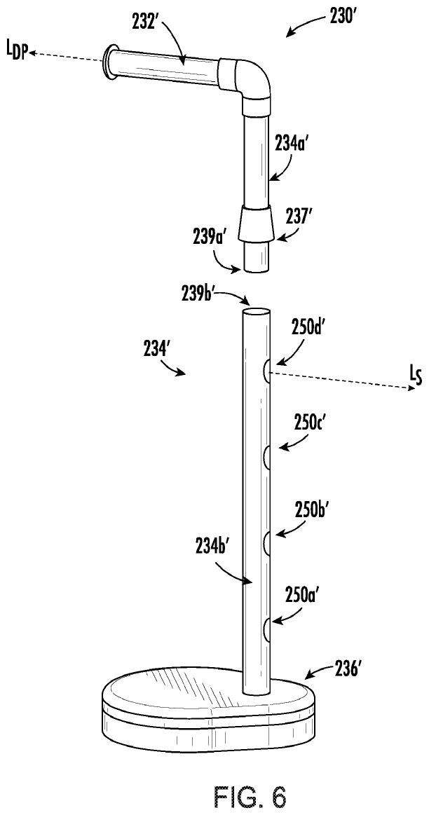

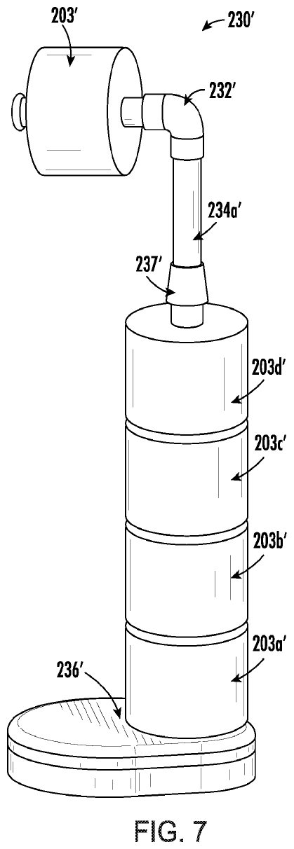

FIGS. 6-7 illustrate another example tissue dispenser 230′ with a dispense portion 232′, a stand portion 234′, and a base portion 236′. The dispense portion 232′ is configured to hold a tissue roll 203′ during dispensing (e.g., the tissue roll 203′ may rotate thereon and enable a user to pull off one or more sections for dispensing). The stand portion 234′ may be an elongated portion configured to hold replacement rolls (e.g., reserve rolls 203a′, 203b′, 203c′, 203d′—shown in FIG. 7). The base portion 236′ is configured to hold the stand portion 234′ and the dispense portion 232′. The base portion 236′ may house circuitry that is used to monitor the amount of replacement rolls on the stand portion 234′. Additionally, the base portion 236′ may include a communication interface that facilitates communication with a remote device (e.g., the cloud/internet), a user's mobile device (such as through a software application on the user's mobile device), a smart hub, and/or other tracking devices. In such a regard, the dispenser 230′ may be able to determine how many replacement rolls are stored thereon and communicate that information to the system for determining and performing re-order functionality accordingly. In some embodiments, the dispenser 230′ may determine and perform the re-order functionality itself.

As shown in FIG. 6, the stand portion 234′ may be separated into multiple parts, such as an upper stand portion 234a′ and a bottom stand portion 234b′. The stand portion 234′ may include multiple sensors (e.g., sensors 250a′, 250b′, 250c′, 250d′—as shown in FIG. 6), where each sensor is positioned along the bottom stand portion 234b′ at an appropriate position to facilitate sensing the presence or absence of a specific reserve roll (e.g., 4 sensors for 4 reserve roll positions). In some embodiments, the top stand portion 234a′ is removably attachable to the bottom stand portion 234b′. When detached, such as shown in FIG. 6, a user is able to remove a tissue roll from the bottom stand portion 234b′ or install a replacement tissue roll onto the bottom stand portion 234b′. Once complete, the user may reattach the top stand portion 234a′ onto the bottom stand portion 234b′, such as by inserting an installation portion 239a′ of the top stand portion 234a′ into a receptacle portion 239b′ of the bottom stand portion 234b′.

Notably, with reference to FIG. 7, a benefit of such a two part stand portion 234′ enables utilization of a stopper 237′ to prevent a user from positioning (or stuffing) a tissue roll onto the top stand portion 234a′—which may otherwise hinder free rotation of a tissue roll installed in the dispensing position. In some embodiments, the stopper 237′ may be used to prevent a user from moving a tissue roll stored on the bottom stand portion 234b′ to the dispense portion 232′.

In some embodiments, the sensors 250, 250′ may be configured to point in a direction that provides less opportunity for a false reading. For example, with reference to FIG. 6, the dispense portion 232′ may extend radially away from the stand portion 234′ in a first radial direction (e.g., along line L_{DP}), wherein the at least one sensor (e.g., sensor 250d′) is aimed radially away from the stand portion 234′ in a second radial direction (e.g., along line Ls) that is different than the first radial direction. In some embodiments, the second radial direction is at least 45 degrees away from the first radial direction in either the clockwise direction or the counterclockwise direction. In some such examples, a false reading, such as the sensor reading the hanging tail of the tissue roll in the dispensing position, can be avoided.

In another example embodiment, the stand portion may include a time-of-flight sensor aimed toward the dispense portion such that the time-of-flight sensor is configured to measure a time-of-flight of a signal emitted toward an outer circumference of an installed tissue roll in the dispensing position. The amount of time between emission of the signal and receipt of a reflected signal corresponding to the emitted signal correlates to an amount of tissue paper remaining on the installed tissue roll.

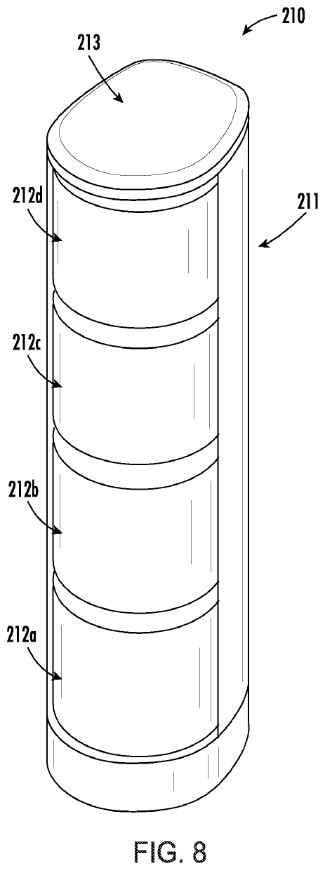

FIG. 8 illustrates an example storage device 210 for holding reserve tissue rolls. In the illustrated embodiment, the storage device 210 includes a base portion 211 and one or more cover portions 212a-d that protect stored tissue rolls (such as from splash of a nearby toilet or shower). In some embodiments, similar to the above detailed stand portions 234, 234′—the storage device 210 may include a sensor in each reserve roll position. In the illustrated embodiment, there are four reserve roll positions, and each position has a corresponding cover portion 212a-d. In some embodiments, each cover portion may be independently openable and closeable. Alternatively, one or more cover portions may be opened and closed together.

In some embodiments, the storage device may be sized to enclose a stand portion and stored replacement tissue rolls stored thereon—e.g., providing a cover for the stand portion. Along similar lines, in some embodiments, a dispenser 230, 230′ may include a cover or a portion of a cover for protecting tissue rolls stored on the stand portion 234, 234′. In some embodiments, a top portion of the cover (e.g., the top 213) may open to enable one or more tissue rolls to be removed.

In some embodiments, the storage device 210 may be adapted, and instead of extending vertically, can extend horizontally (e.g., with adjacent tissue rolls being lined up next to each other instead of being stacked on top of each other). In such an embodiment, the storage device may include one or more mounting features that enable it to be mounted, such as over the back of a toilet.

### Example Tissue Spindles

FIG. 9 illustrates an example spindle 40′ that may be used with example systems described herein. The spindle may include one or more sensors that track usage of tissue paper rolls. For example, the spindle may include a sensor that senses when a replacement tissue paper roll has been put on the spindle—thereby enabling a decrement to the overall inventory. Additionally, the spindle may include a communication interface capable of transmitting the sensed data to a remote device.

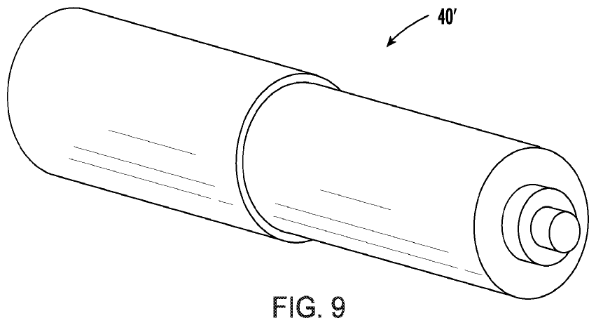

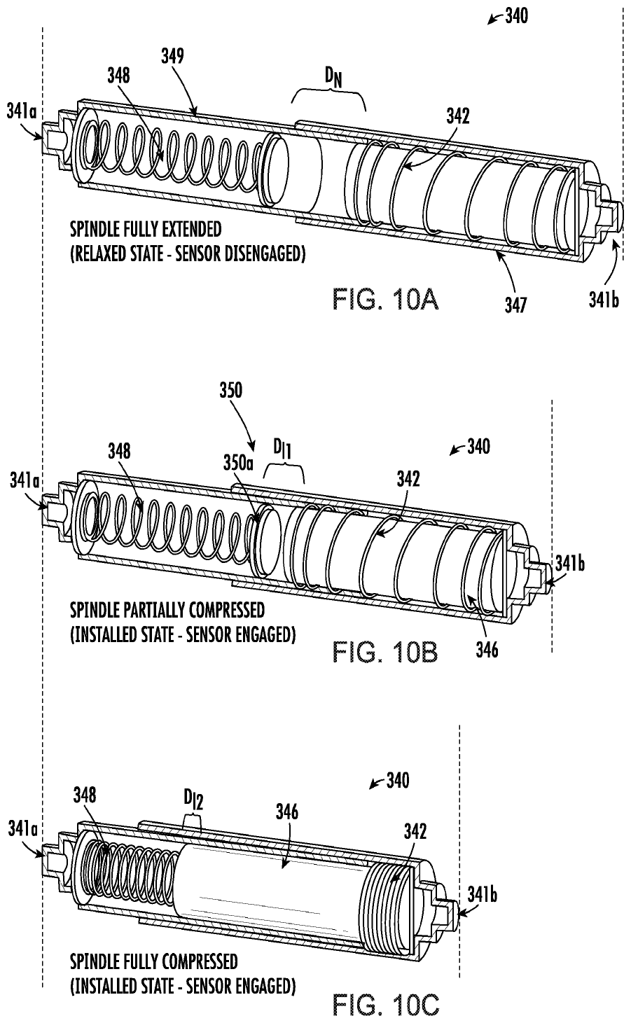

With reference to FIGS. 10A-10C, an example spindle 340 for enabling dispensing of tissue paper is illustrated in various compression states. Although the following describes a spindle in conjunction with tissue rolls, some embodiments contemplate the same or similar features/functions with respect to other sheet product rolls (such as paper towel rolls, napkin rolls, etc.).

The spindle 340 is configured to fit within conventional tissue spindle holders, such as are likely positioned near a toilet in a bathroom of a household. For example, the spindle 340 may include installation protrusions 341a, 341b on each side that extend outwardly in a longitudinal direction. The installation protrusions 341a, 341b may be designed to fit within corresponding installation holes of tissue spindle holders. Further, the spindle 340 may include a main body spring 342 and two telescoping body portions (e.g., main body portion 347 and sensor body portion 349) that enable the spindle 340 to be retracted (e.g., compressed) and extended along a longitudinal axis of the spindle. In such a manner, a user may compress the spindle 340 to enable insertion of the installation protrusions 341a, 341b into the corresponding installation holes of the tissue spindle holder. The bias of the main body spring 342 of the spindle 340 may be configured such that the spindle is biased to a fully extended state (FIG. 10A) so that the spindle extends to cover the width of the tissue spindle holder to complete installation (e.g., a user may have put a replacement tissue paper roll on the spindle for installation into the tissue spindle holder). In this regard, the example spindles can be easily installed into a wide variety of tissue spindle holders without needing to change bathroom fixtures.

In the illustrated embodiment of FIGS. 10A-C, the example spindle 340 is designed with at least one sensor 350 that is configured to determine when the spindle has entered a fully extended (e.g., relaxed) state and/or when the spindle has entered an installed state. In this regard, the sensor 350 may be configured to determine when a theoretical roll change (e.g., removal of an empty tissue paper roll and replacement with a new tissue paper roll) has occurred. In this regard, in some embodiments, the system may assume that a roll change has occurred when the sensor in the spindle indicates that the spindle has entered a fully extended (e.g., relaxed) state (e.g., shown in FIG. 10A), since such a situation usually corresponds to occurrence of a roll change. Notably, however, as indicated herein, the system may be configured to utilize other inputs or factors to determine if the event should be ignored or not counted. For example, if multiple events (e.g., trips) of the sensor are indicated within a certain amount of time (e.g., within a short amount of time), then the system may ignore all but one of the events. As another example, the user may be offered a chance to indicate whether to apply a decrement to the inventory count based on one or more indicated events of the sensor. As a further example, a weight sensor (such as in the electronics shuttle 346) may be installed in the spindle and utilized to determine if a new tissue roll was installed (e.g., based on the weight sensed by the weight sensor). In some cases the weight sensor may be used to estimate the amount of the product remaining on the tissue roll, such as at various points through the life cycle of the tissue paper roll dispensing. Other fuel gauge sensors are also contemplated. Moreover, other possible factors are also contemplated. For example, in some embodiments, a user input may be provided on the spindle to enable a user to provide an indication that a replacement roll has been installed (or not installed), such as via one or more buttons (e.g., physical or “touch” enabled).

The sensor 350 may be any type of sensor configured to sense entrance of the spindle into the fully extended state and/or into an installed state. For example, a magnetic switch sensor (e.g., a reed switch) may be used. In the illustrated embodiment, a first sensor part 350a is positioned within the sensor body portion and is biased via a sensor spring 348 toward the fully extended state (e.g., the first sensor part 350a is biased to a fully extended sensor position). A second sensor part (e.g., contained within the electronics shuttle 346) may be positioned within the main body portion 347 and may be attached (such as via the electronics shuttle) to an end of the main body portion 347 opposite the sensor body portion 349. In some embodiments, the electronics shuttle 346 may be configured with a diameter and/or width (if non-cylindrical) that is less than the internal width of the sensor body portion 347 such that at least a portion of the electronics shuttle 346 may fit within the sensor body portion when the spindle 340 is compressed (such as in the fully compressed state shown in FIG. 10C). In this regard, in some embodiments, the main body spring 342 may be configured to surround the electronics shuttle 346.

When the first sensor part 350a is within a certain distance of the second sensor part, the sensor 350 may enter a closed state indicating that the spindle 340 is in an installed state. Examples of this are shown in FIGS. 10B (sensor distance D_{II}) and 10C (sensor distance Du). However, when the spindle 340 is fully extended, there may be sufficient distance (sensor distance D_{N}) between the first sensor part 350a and the second sensor part such that the sensor 350 enters an open state, thereby indicating that the spindle 340 has entered the fully extended (e.g., relaxed state). Although the above example details a magnetic sensor, other types of sensors are contemplated, such as a mechanical switch sensor, a horizontal magnetic switch (e.g., where the magnets cross over top of each other as the spindle compresses), a plunger switch, etc.

In some embodiments, the spindle 340 may include one or more communication interfaces configured to transmit data (e.g., sensor data) to a remote device (e.g., a smart hub, the user's mobile device (such as through the software application), a remote server, etc.). In some embodiments, the communication interface may comprise a transmitter and/or receiver to enable transmission of the data. In some embodiments, the communication interface may utilize Z-Wave or Zigbee communication protocol for the data transmission (or other communication protocol or options, such as cellular, etc.). In some embodiments, the communication interface may be housed within the electronics shuttle.

In some embodiments, a battery (e.g., power source) and/or other electronics (e.g., a processor) may be stored within the electronics shuttle 346 along with the communication interface and/or second part of the sensor. In some embodiments, the spindle may be configured with some wake-up functionality that limits when the spindle communicates the data. For example, the spindle may only transmit data once the sensor senses an event.

Notably, however, the installed state may occur over a wide variation of widths of tissue spindle holders, as some embodiments are designed to work with many different bathroom tissue spindle holders—which may come in varying widths. To explain, the illustrated embodiment is configured to provide the automatic tracking and re-order functionality with tissue spindle holders that have a wide variation in widths, to include widths varying from a first distance corresponding to the spindle's fully compressed state (shown in FIG. 10C) to a second distance corresponding to slightly less than the spindle's fully extended state (e.g., consider FIG. 10B, which shows an example installed state where the sensor is engaged and the spindle is partially compressed, versus FIG. 10A, which shows an example fully extended state). In this regard, the illustrated example includes two springs: a main body spring 342 and a sensor body spring 348. The main body spring 342 biases the main body portion 347 away from the sensor body portion 349 so as to bias the spindle 340 into the fully extended (e.g., relaxed stated). The sensor spring 348 biases the first sensor part 350a toward the electronics shuttle 346 (in the main body portion 347) and in a position (e.g., a fully extended sensor position) such that the first sensor part 350a will enable sensing of when the spindle is only slightly compressed—such as if the spindle is installed in a tissue spindle holder that is relatively wide (e.g., 6.5 in. in width). However, in the fully extended (e.g., relaxed) state the second sensor part (and the electronics shuttle 346) are outside of the range of the first sensor part 350a such that the sensor is open (as described herein and shown in FIG. 10A). Further, however, since the first sensor part 350a is able to move within the sensor body portion 349, the first sensor part 350a can be moved further into the sensor body portion 349 to enable more full compression of the spindle 340 while enabling sensing of an installed state (shown in FIG. 10C). Finally, the sensor spring 348 biases the first sensor part 350a back toward the main body portion 349 such that when the main body portion 349 is released the first sensor part 350a will also extend (by virtue of the sensor spring 348) to enable sensing of an installed state when the spindle 340 moves to a partially compressed (but still installed) state (such as shown in FIG. 10B).

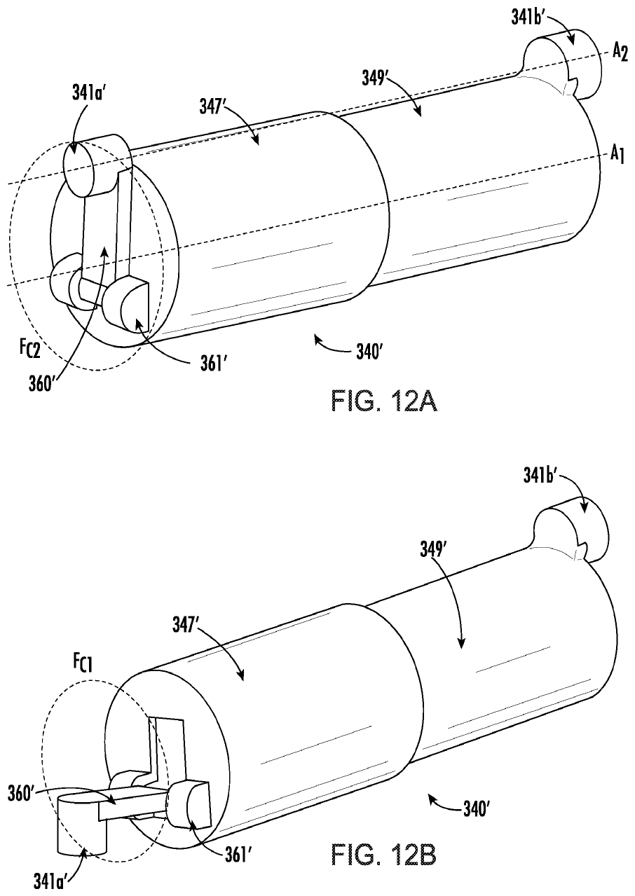

In some cases, a user may want to install an oversized tissue roll into a recess-mounted tissue holder in a wall. Unfortunately, the recess-mounted tissue holder may be designed to only hold a smaller-sized tissue roll. In order to enable oversized tissue rolls to be installed in such recess-mounted tissue holders, some tissue spindles may be formed with installation protrusions that are offset from a center axis of the spindle. Notably, some spindles and offset installation protrusions still together define a circumferential footprint that allows insertion in and through a central opening of the tissue roll (e.g., installation of the tissue roll onto the spindle) before installing the spindle and installed tissue roll into the tissue holder. However, due to the need for electronics being contained in the spindle, such a spindle and offset installation protrusions would together form too large a circumferential footprint to fit within the central opening of a tissue roll (e.g., consider the circumferential footprint F_{C2} in FIG. 12A). Thus, in some embodiments, one or both of the offset installation protrusions are configured to move between a disengaged position that is laterally within the circumferential footprint of the spindle for insertion through the central opening of the tissue roll (e.g., consider the circumferential footprint F_{C1} in FIG. 12B) and an engaged position that positions the installation protrusion in an offset manner to enable installation of the spindle and oversized tissue roll into the recess-mounted tissue holder.

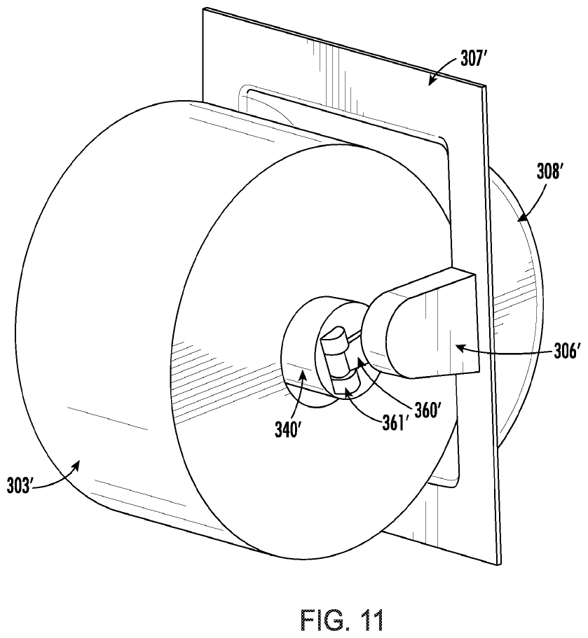

For example, FIG. 11 shows an example tissue spindle 340′ with extended installation protrusions that enable use of an over-sized tissue roll 303′ in a recess-mounted tissue holder 307′. In this regard, the recess-mounted tissue holder 307′ includes a recessed shell 308′ that sits within a wall and roll holders 306′ that extend outwardly therefrom. The extended installation protrusions are installed within the roll holders 306′.

FIG. 12A shows the example tissue spindle 340′ with the extended installation protrusions 341a′, 341b′ in the engaged position. FIG. 12B shows the example tissue spindle 340′ with an extended installation protrusions 341a′ in the disengaged position. Notably, when in the engaged position, the extended installation protrusions 341a′, 341b′ are aligned along a second axis (A₂) that is offset from a center axis (A₁) of the spindle 340′. However, in that configuration, when adding in the increased circumferential size of the spindle 340′, the overall combined circumferential footprint F_{C2} of the spindle 340 and the extended installation protrusions 341a′, 341b′ are too large for fitting through a central opening of a tissue roll. Thus, in order to allow insertion through the central opening, one of the extended installation protrusions 341a′ is rotatably connected to the main body portion 347′ of the spindle 340′. In particular, the extended installation protrusion 341a′ is attached to an arm 360′ that is rotatably (e.g., pivotably) connected around an axis defined by 361′. As shown in FIG. 12B, the extended installation protrusion 341a′ has been rotated to the disengaged position to cause it to fit within the circumferential footprint F_{C1} of the main body portion 347′ for insertion through the central opening of the tissue roll. After insertion is complete, the extended installation protrusion 341a′ may be rotated back to the engaged position (shown in FIG. 12A) for installation into the roll holder.

### Example Paper Towel Dispensers

In some embodiments, automated and manual paper towel dispensers may include one or more sensors that are configured to sense when a paper towel roll is replaced and/or how much paper towel is dispensed. Although the following describes the holders and dispensers in conjunction with paper towel rolls, some embodiments contemplate the same or similar features/functions with respect to other sheet product rolls (such as tissue rolls, napkin rolls, etc.).

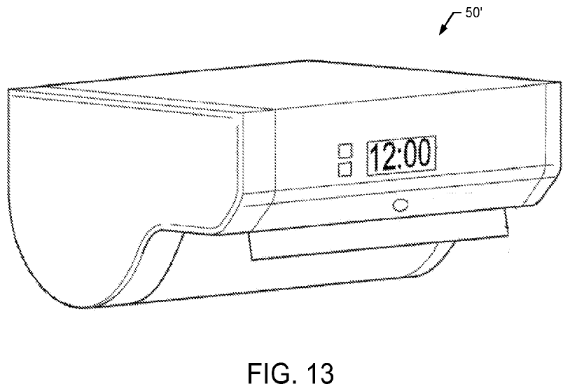

FIG. 13 illustrates an example automated paper towel dispenser 50′ for use with example systems described herein. The paper towel dispenser may be configured to hold a paper towel roll and operate to cause dispensing of a portion of the paper towel roll, such as in response to a user request (e.g., activation of an activation sensor). Additionally, the paper towel dispenser may store one or more replacement paper towel rolls. The paper towel dispenser may include one or more sensors that track usage of the paper towel roll(s) installed therein. For example, the paper towel dispenser may include a sensor that senses when a replacement tissue paper roll has been put on the holder—thereby enabling a decrement to the overall inventory count. In some embodiments, the paper towel dispenser may include one or more sensors that measure the amount of paper towel dispensed. Additionally, the paper towel dispenser may include a communication interface capable of transmitting the sensed data to a remote device.

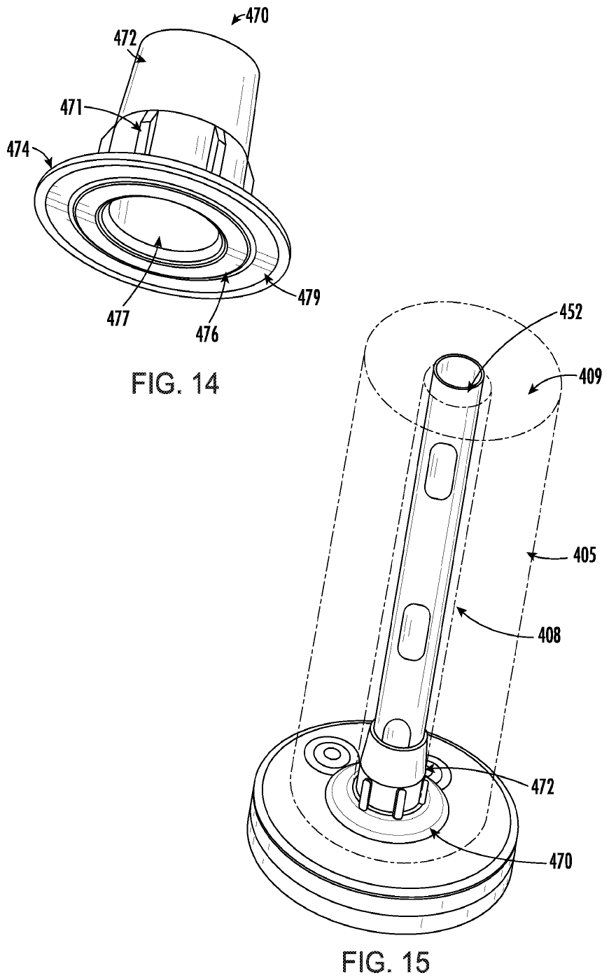

FIG. 14 illustrates an example paper towel holder 470. The paper towel holder 470 (which may be referred to as a “collar”) includes a body that is defined by an installation portion 472 configured to fit within a core opening 408 of an installed paper towel roll 405 (e.g., shown in FIG. 15). For example, the installation portion 472 may include one or more fins 471 that fit within and push against the inside surface of the core opening 408 of the paper towel roll 405—such as to maintain connection between the paper towel holder 470 and the paper towel roll 405. The paper towel holder 470 also includes a base portion 474 extending radially outward from the installation portion 472 and along a side 409 of the installed paper towel roll 405. A sensor may be positioned within the body and configured to sense the presence or absence of the installed paper towel roll, such as through the installation portion 472. The paper towel holder 470 may include a communication interface configured to transmit sensor data to a remote device, wherein the sensor data indicates the presence or absence of the installed paper towel roll.

The paper towel holder 470 may include a hole 477 extending through the base portion 474 and the installation portion 472. The hole 477 may be configured to removably receive a stand portion 452 of a paper towel roll dispenser 450 therethrough (e.g., shown in FIGS. 14 and 15).

In some embodiments, the base portion 474 defines a bottom surface that is configured to enable an installed paper towel roll 405 to be supported on a surface by the base portion 474 in a vertical orientation without any portion of the installed paper towel roll needing to touch the surface (e.g., the ground, the counter surface, etc.). In this regard, the paper towel holder 470 may include a friction surface 479, such as a rubber surface, that may help maintain the position of the holder 470 when it is placed on the surface. In such a regard, the paper towel holder 470 may enable hygienic use (e.g., avoid the installed paper towel roll from contacting the surface).

In some embodiments the paper towel holder 470 may include a magnet 476 that may be used for positioning of the paper towel holder 470. For example, the paper towel holder 470 could be stuck against a corresponding magnetic surface, such as a refrigerator.

In some embodiments, a “collar” or similar device may be utilized with other types of products (e.g., toilet tissue, aluminum foil, tape, plastic wrap, gift wrap, etc.). In this regard, the “collar” may be designed to be held by such other products and may, in some embodiments, be configured to work with corresponding dispensers for such products (e.g., similar to as described with respect to paper towel dispensers below).

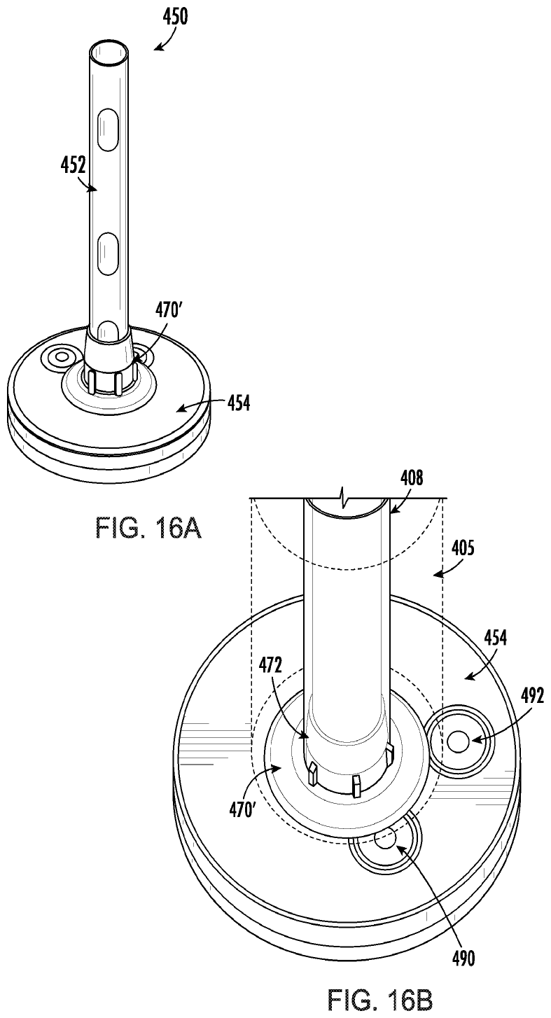

In some embodiments, the paper towel holder 470 may be configured to interact with and/or form a part of a paper towel dispenser 450, such as illustrated in FIG. 16A. The paper towel dispenser 450 includes a stand portion 452 configured to fit within an installed paper towel roll 405 (shown in FIG. 16B). The paper towel dispenser 450 further includes a base portion 454 extending radially outward from the stand portion 452. The base portion 454 is configured to support the stand portion 452 such that the stand portion 452 extends vertically from the base portion 454.

The base portion 454 includes at least one sensor configured to sense the presence or absence of the installed paper towel roll. In the illustrated embodiment, the paper towel dispenser 450 includes two sensors 490, 492. Each sensor 490, 492 is oriented vertically toward the side of the installed paper towel roll to detect the presence or absence of paper towel. Notably, the first sensor 490 (“S1”) positioned a first radial distance from the stand portion 452 such that the first sensor 490 is configured to detect the presence or absence of paper towel at the first radial distance (e.g., when the amount of paper towel on the installed paper towel roll is greater than or equal to an amount corresponding to a radius of a paper towel roll that extends to the sensor 490). The second sensor 492 (“S2”) is also oriented vertically toward the side of the installed paper towel roll and is positioned a second radial distance from the stand portion 452 such that the second sensor 492 is configured to detect the presence or absence of paper towel at the second radial distance, wherein the first radial distance is different (e.g., shorter) than the second radial distance. In this regard, the second sensor 492 may detect the paper towel on the installed paper towel roll when the amount is greater than or equal to an amount corresponding to a radius of the roll that extends to the sensor 492.

In some embodiments, by utilizing the difference in distance between the sensors from the stand portion 452, a controller can determine different threshold amounts off paper towel on an installed roll. For example, when both sensors 490, 492 indicate that paper towel is present, then the amount of paper towel is known to be at least an amount equivalent to an amount corresponding to the paper towel roll having a radius extending to the second sensor 492, which may for example correspond to 50% of the original amount of paper towel (although other percentages are contemplated). However, when only the first sensor 490 indicates that paper towel is present (and the second sensor 492 indicates that paper towel is not present), then the controller may determine that there is a different amount of paper towel on the roll—such as may be equal to an amount corresponding to when a roll has a radius equal to the distance to the first sensor 490—such as may correspond to 15% of the original amount of paper towel (although other percentages are contemplated). Such information (e.g., sensor data) can be communicated to a remote device, such as through a communication interface. Thereafter, the sensor data can be utilized by the tracking and re-order system accordingly, such as to decrement inventory and/or notify a user (e.g., send a notification that a replacement paper towel roll is (or will be) needed).

In the illustrated embodiment, the paper towel dispenser 450 also includes a paper towel holder 470′. The paper towel holder 470′ may include the same or similar features/components as the paper towel holder 470 described with respect to FIGS. 14-15. However, in some embodiments, the paper towel holder 470′ may not include a sensor and/or corresponding circuitry components (e.g., a controller, communication interface, etc.). In such example embodiments, the paper towel holder 470′ may still perform desirable functions such as allowing a user to easily remove an installed paper towel roll for remote use (e.g., bring it to the site for use in clean up). In this regard, the paper towel holder 470′ may stay with the paper towel roll 405. Additionally, however, the paper towel holder 470′ may include one or more holder position sensors, such as a magnet 476 (shown in FIG. 14), that enables determination that the paper towel holder 470′ is installed or not installed on the paper towel dispenser 450. Such a feature may enable additional determinations that may account for a scenario where the user does not “replace” a paper towel roll and, instead, merely moves the paper towel roll and puts the same paper towel roll back on the paper towel dispenser 450 (e.g., the operating status would be still “in use” as opposed to recently “replaced”). This would avoid an improper determination that a replacement of the roll had occurred, otherwise leading to an improper decrement in the inventory level for the household environment. In some embodiments, this could be confirmed by sensor data from one or more of the sensors 490, 492 indicating that a similarly sized paper towel roll was reinserted into the paper towel dispenser 450 (e.g., as from a last stored “amount”).

In some embodiments, utilizing the data of the holder position sensor may enable determining whether or not the paper towel holder is “lost or missing”. In such an example, the sensors 490, 492 may indicate that paper towel is present, but the holder position sensor may indicate that the paper towel holder 470′ is not present.

The following TABLE 1 provides some example determinations that can be made based on sensor data received from the various sensors of the paper towel dispenser 450.

TABLE 1

| State | Collar | S1 | S2 | Description |
|---|---|---|---|---|
| A | 0 | 0 | 0 | User has removed towel roll from stand |
| B | 1 | 0 | 0 | Towel roll is nearly depleted |
| C | 1 | 1 | 0 | Towel is > S1 diameter, and < S2 diameter |
| D | 1 | 1 | 1 | Towel > S2 diameter |
| E | 0 | x | 1 | Collar Missing or lost |
| F | 0 | 1 | x | Collar Missing or lost |

In some embodiments, the paper towel holder 470 may comprise one or more non-continuous magnets that wrap around a portion of the circumference of the paper towel holder 470 (such as the base portion 474). Multiple magnets may be separated by spaces. A magnet sensor may be positioned on the base portion 454 of the paper towel dispenser 450 and configured to sense the one or more non-continuous magnets as the paper towel roll 405 rotates to measure the rotation of the paper towel roll 405 as it is consumed. A two magnetic sensor approach can also be used to measure rotational direction. Further, in some embodiments, the speed of rotation of the magnet(s) may also help detect whether the paper towel roll 405 is large (few rotations within a time period) or small (many rotations within the time period).

In some embodiments, the two optical sensors can be spaced (such as instead of 2 magnetic sensors) so they are out of phase. For this optical encoder approach, the paper towel holder 470 could have holes spaced around the circumference that can block the light or let light through (e.g., similar to a slotted disk).

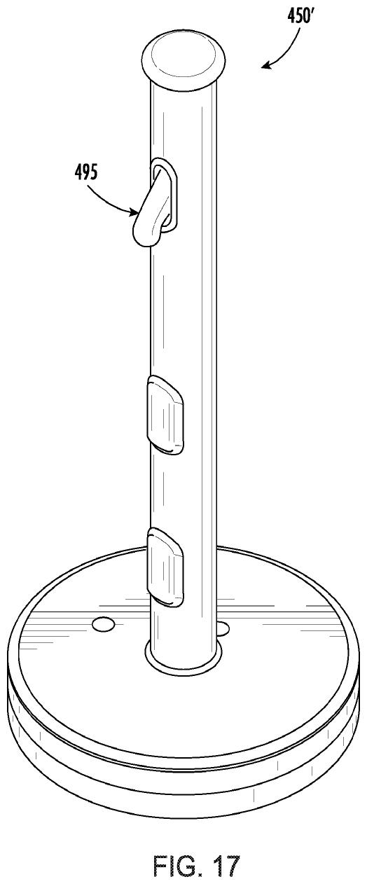

FIG. 17 illustrates another example paper towel dispenser 450′ that does not include a paper towel holder 470. Instead, the paper towel dispenser 450′ includes a switch 495 that is depressed when a user installs the paper towel roll. In some embodiments, depression of the switch may provide an indication to a controller of the paper towel dispenser 450′ which may be used, such as for wake-up functionality or the like. In some embodiments, the switch 495 may provide a “drag” force against the inside of the installed paper towel roll 405 that may assist in preventing overspin.

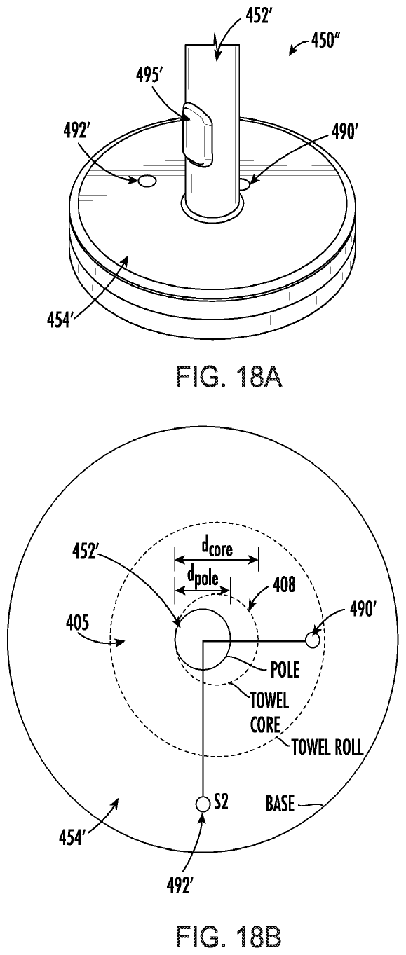

FIG. 18A illustrates a similar paper towel dispenser 450″ as the paper towel dispenser 450′, but the switch 495 is an optical sensor 495′ (“S0”) (although other types of sensors are contemplated, such as time-of-flight, infrared, capacitance, etc.). By utilizing the various sensors, different determinations may be made by the controller. For example, if the optical sensor 495′ is not registering paper towel, but one or more of the other sensors 490′, 492′ are, then the optical sensor 495′ may be dirty or malfunctioning. Likewise, if the optical sensor 495′ is registering paper towel, but the two sensors 490′, 492′ are not, then the paper towel roll may be nearly depleted. The following TABLE 2 provides some example determinations that can be made based on sensor data received from the various sensors of the paper towel dispenser 450″.

TABLE 2

| State | S0 | S1 | S2 | Description |
|---|---|---|---|---|
| A | 0 | 0 | 0 | User has removed towel roll from stand |
| B | 1 | 0 | 0 | Towel roll is nearly depleted |
| C | 1 | 1 | 0 | Towel is > S1 diameter, and < S2 diameter |
| D | 1 | 1 | 1 | Towel > S2 diameter |
| E | 0 | x | 1 | Sensor S2, or S0, is dirty or malfunctioning |
| F | 0 | 1 | x | Sensor S1, or S0, is dirty or malfunctioning |

FIG. 18B illustrates an example desired positioning of the first sensor 490′ and the second sensor 492′ with respect to the stand portion 452′.

The radius from the stand portion 452′ that the first sensor 490′ (“S1”) and the second sensor 492′ (“S2”) are placed at, rs1 and rs2, may be important for the optimal operation of the device in order to detect the operating states noted in TABLE 2. For example, a single sensor, S1, could be used to save cost, but then there may be corner cases that arrive, such as when a roll is close to the same radius that the S1 sensor is at, and because the stand portion 452′ is smaller than the core 408 of the roll 405, the position of the roll 405 around the stand portion 452′ can vary. This could cause the same roll to block S1 (such that S1 registers paper towel) or not block S1 (such that S1 registers no paper towel) depending on the position of the core 408 around the stand portion 452′. In this regard, the roll can shift by: rollShift=dcore−dpole, as shown in FIG. 18B.

By going to a second sensor, S2, at a different radius than S1, the system now has hysteresis to account for this shift. By making rS2>rS1 by more than rollShift, you can guarantee that a roll won't cover both S1 and S2 just due to the roll placement around the stand portion 452′. Note that although FIG. 18B shows a cylindrical towel roll and core, in practice these can be noncircular due to roll compression, so rollShift may also account for the maximum shift that could be seen with a noncircular roll. The position of S1, at rS1, could also account for rollShift, by making rS1>rollShift to prevent an empty core from covering S1. The position of S2, at rS2, could also account for the smallest diameter “new” roll that is expected, and rollShift of that roll, so that S2 is guaranteed to be covered by this smallest expected new roll no matter where the roll is placed on the pole (rS2<=½ smallest diameter new roll−rollShift). So in summary, example constraints on S1 and S2 placement for an example optimal operation may be:
rS1>rollShift
rS2>rS1+rollShift
rS2<=½ smallest diameter new roll—rollShift

In some embodiments, the first sensor 490′ and second sensor 492′ may be positioned along different directions extending radially outward from the stand portion 452′. For example, in order to account for a shifting position of the core 408 of the installed roll 405 around the stand portion 452′, the first direction (for the first sensor 490′) may be angularly separated from the second direction (for the second sensor 492′) such as by an angle of 45 degrees or greater (although any angle is contemplated). In this regard, when the sensors 490′, 492′ are not aligned, the difference between the sensors may account for the shifting of the roll such as to enable a more accurate estimation of the remaining amount of paper towel on the roll.

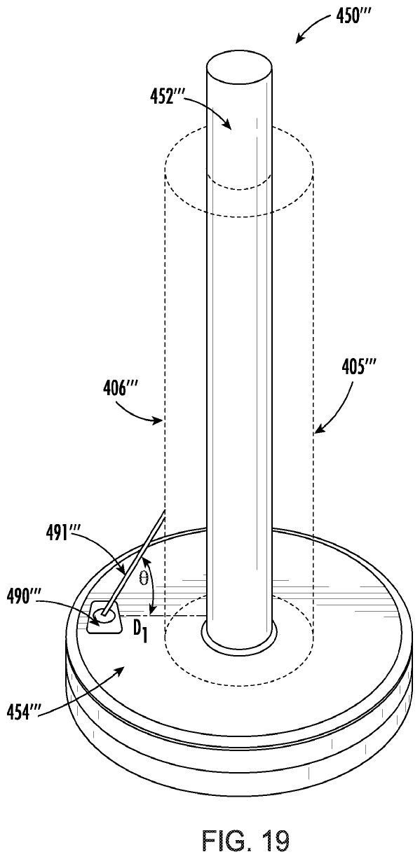

In some embodiments, a time-of-flight sensor may be used. In some such embodiments, the time-of-flight sensor may be positioned in the base and angled upwardly and toward the installed paper towel roll to enable fuel gauging. For example, FIG. 19 illustrates another example paper towel dispenser 450″. Notably, the paper towel dispenser 450′″ in FIG. 19 includes a single time-of-flight sensor 490′″ that is directed at angle upward and toward the paper towel roll (e.g., the beam 491′″ is directed at an angle θ upwardly with respect to the top surface of the base portion 454′″). By knowing the angle θ at which the time-of-flight sensor points toward the paper towel roll 405′″, and determining the time of return of the signal, the amount of paper towel remaining on the paper towel roll 405′″ can be determined. To explain, the time-of-flight sensor 490′″ is positioned a radial distance Di away from the stand portion 452′ and angled upwardly and toward the stand portion 452′ such that the sensor is configured to measure a time-of-flight of a signal 491′ emitted toward an outer circumference 406′ of the installed paper towel roll 405′″. The amount of time between emission of the signal and receipt of a reflected signal corresponding to the emitted signal correlates to an amount of paper towel remaining on the installed sheet product roll 405′″.

In some embodiments, this sort of fuel gauging may be useful for determining if a user has simply removed and replaced the same paper towel roll—which could otherwise falsely effect the overall household inventory. For example, if a removal event occurs, then the time-of-flight sensor could be used to see if a less than a full paper towel roll was put back (it could also be less than the previous reading). If however, too big of a fuel gauge difference occurs or more paper towel is on the “new” paper towel roll, then the system may determine that a paper towel roll was indeed replaced.

### Example Napkin Holders

In some embodiments, a napkin holder is contemplated for use with various tracking and re-order systems described herein. Notably, while the napkin holder described herein is described with respect to napkins, other sheet product or stackable consumable products (e.g., non-sheet product) may be tracked using the same or similar features for a consumable products holder.

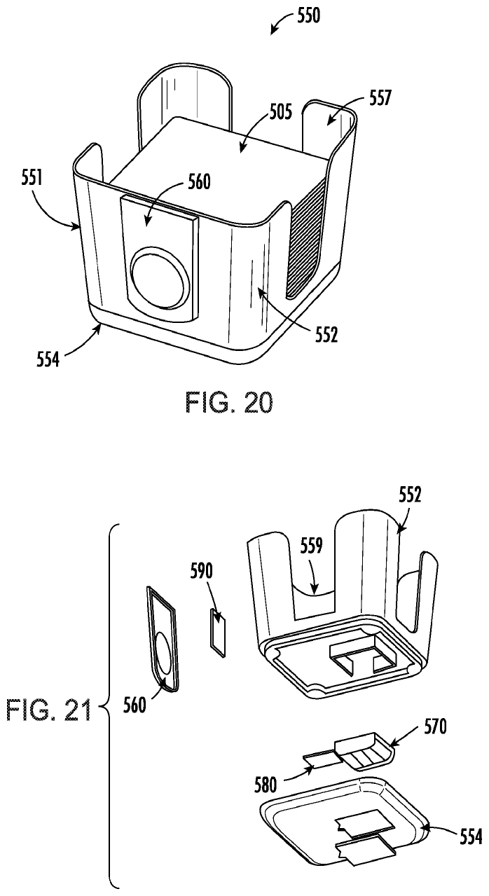

FIGS. 20-21 illustrate an example napkin holder 550 for holding and tracking a supply of napkins 505. In the illustrated embodiment, the napkin holder 550 includes a body 551 with a base portion 554 and a receptacle portion 552 that includes a space 557 for receiving a supply of napkins 505 (e.g., a stack of napkins). A sensor module 560 is positioned within a slot 559 of the receptible portion 552. The sensor module 560 includes a sensor 590 configured to determine the presence or absence of the napkins at a certain level within the receptacle portion 552. Additionally, the napkin holder 550 may include a controller and/or a communication interface, such as on a printed circuit board 580 housed in the base portion 554 (although the controller and/or communication interface may be positioned anywhere in the napkin holder 550). The communication interface may be capable of transmitting the sensed data from the sensor 590 to a remote device. Notably, one or more batteries 570 may also be stored in the base portion 554 (or other portion) and provide power to the various components/features of the napkin holder 550.

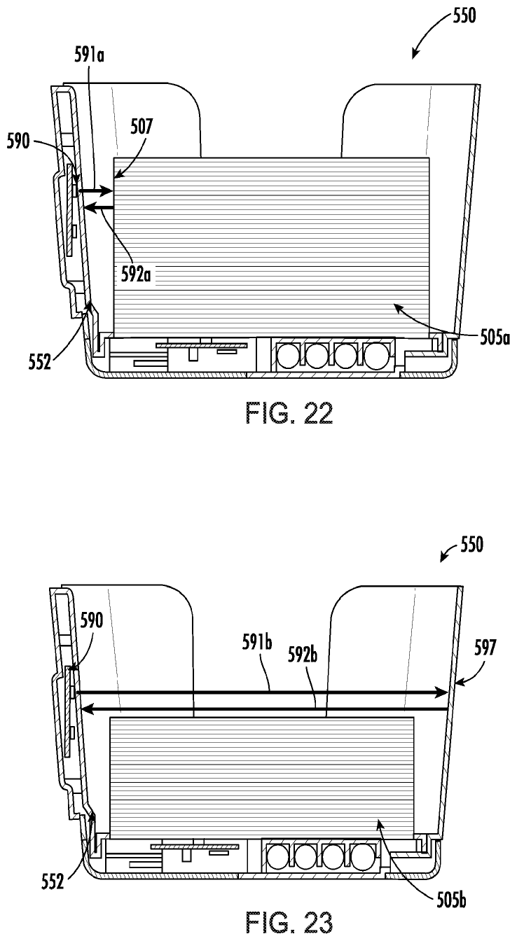

With reference to FIG. 22, the sensor 590 may be placed at a vertical position in the receptacle portion 552 that corresponds to determination of a desired threshold amount of napkins in the receptacle portion 552. In this regard, the sensor 590 may be configured to transmit a signal 591a at the vertical position across the receptacle portion 552 so as to be directed toward a side surface 507 of the supply of napkins 505a. If a sufficient amount of napkins are in the supply 505a (such as shown in FIG. 22), the signal 591a will reflect off the side 507 and form a return signal 592a that will be received at the receiver of the sensor 590. In such a manner, the sensor 590 may detect the presence of the supply of napkins 505a at the threshold level within the receptacle portion 552.

In some embodiments, the sensor 590 may be a time-of-flight sensor that provides time stamps associated with the signals 591a, 592a so as to enable determination that a time period that has elapsed between transmitting the signal 591a and receiving the return signal 592a is within a threshold time period—thereby indicating that a level of napkins 505a is present in the receptacle portion 552. However, if an insufficient level of napkins 505b is present in the receptacle portion 552 (such as shown in FIG. 23), then either no return signal will be received or a return signal 592b that reflects off a different surface (such as an opposite wall 597 of the receptacle portion 552) will be received. In either case, a certain amount of time will have elapsed after transmission of the signal 591b that will indicate that there is not a sufficient level of napkins 505b present within the receptacle portion 552. Such sensor data may be communicated to the system for use therein, such as for determining an amount of napkins present in the napkin holder 550 and/or for inventory control. Notably, although not shown, different and/or additional types of sensors may be utilized with the contemplated napkin holder 550 (e.g., weight based sensors, infrared sensors, etc.). For example, positioning another sensor at a different vertical position may provide a further threshold level that may correspond to an amount of consumable product remaining.

In some embodiments, one or more sensors may be oriented differently within the napkin holder 550. For example, a sensor may be positioned at an angle (e.g., at least partially downwardly) toward the supply of napkins 505. In such example embodiments, by utilizing a time-of-flight sensor, the amount of time that has elapsed from transmitting the signal to receiving the return signal can be used, such as by a controller, to determine/estimate the amount of napkins within the receptacle portion 552.

In some embodiments, the napkin holder 550 may use a weight-based sensor, such as positioned in the base portion 554 to measure an amount of napkins in the receptacle portion 552 (e.g., based on the sensed weight). In some embodiments, one or more optical sensors can be oriented to measure down to the top surface of the supply of napkins to determine the amount of napkins in the receptacle portion 552. In some embodiments, a mechanical arm or lever can sit on top of the supply of napkins, and the change of angle can be used to measure the consumption and/or current amount of napkins in the receptacle portion 552. In some embodiments, a conductive plate can be used to hold down the supply of napkins, and an inductive or magnetic sensor can be positioned within the napkin holder 550 and used to monitor the level of the supply of napkins accordingly. In some embodiments, the napkins may be stacked horizontally, and a linear potentiometer is pushed against the last of the supply (such as via a spring bias)—and the linear potentiometer may indicate the amount of napkins remaining.

### Example Paper Plate Holders

In some embodiments, a paper plate holder is contemplated for use with various tracking and re-order systems described herein. Notably, while the paper plate holder described herein is described with respect to paper plates, non-paper plates (e.g., Styrofoam, plastic, etc.) or stackable consumable products (e.g., non-plates) may be tracked using the same or similar features.

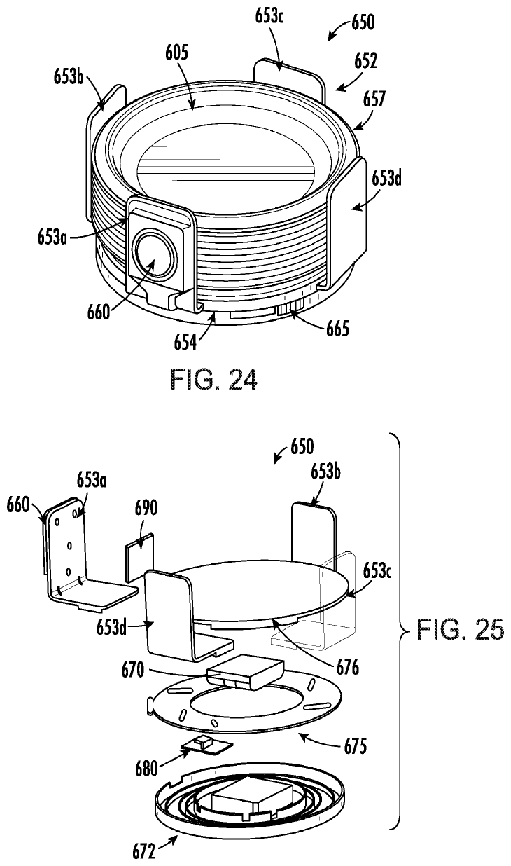

FIGS. 24-25 illustrate an example paper plate holder 650 for holding and tracking a supply of paper plates 605. In the illustrated embodiment, the paper plate holder 650 includes a base portion 654 and a receptacle portion 652 that includes a space 657 defined between four guide plates 653a-d for receiving a supply of paper plates 605 (e.g., a stack of paper plates—though non-paper plates could be used—as noted above). A sensor module 660 is positioned on one of the guide plates 653a and includes a sensor 690 configured to determine the presence or absence of the paper plates at a certain level within the receptacle portion 652. Additionally, the paper plate holder 650 may include a controller and/or a communication interface, such as on a printed circuit board 680 housed in the base portion 654 (although the controller and/or communication interface may be positioned anywhere in the paper plate holder 650). The communication interface may be capable of transmitting the sensed data from the sensor 690 to a remote device. Notably, one or more batteries 670 may also be stored in the base portion 654 (or other portion) and provide power to the various components/features of the paper plate holder 650.

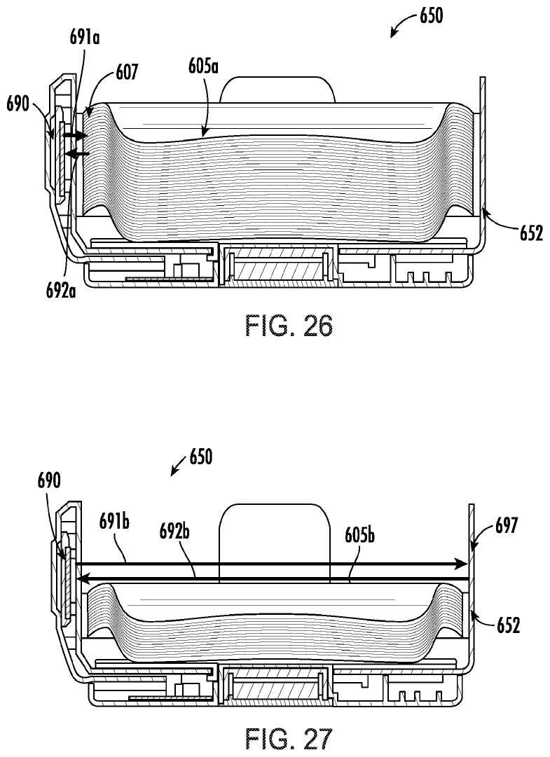

With reference to FIG. 26, the sensor 690 may be placed at a vertical position in the receptacle portion 652 that corresponds to determination of a desired threshold amount of paper plates in the receptacle portion 652. In this regard, the sensor 690 may be configured to transmit a signal 691a at the vertical position across the receptacle portion 652 so as to be directed toward a side surface 607 of the supply of paper plates 605a. If a sufficient amount of paper plates are in the supply 605a (such as shown in FIG. 26), the signal 691a will reflect off the side 607 and form a return signal 692a that will be received at the receiver of the sensor 690. In such a manner, the sensor 690 may detect the presence of the supply of paper plates 605a at the threshold level within the receptacle portion 652.

In some embodiments, the sensor 690 may be a time-of-flight sensor that provides time stamps associated with the signals 691a, 692a so as to enable determination that a time period that has elapsed between transmitting the signal 691a and receiving the return signal 692a is within a threshold time period—thereby indicating that a level of paper plates 605a is present in the receptacle portion 652. However, if an insufficient level of paper plates 605b is present in the receptacle portion 652 (such as shown in FIG. 27), then either no return signal will be received or a return signal 692b that reflects off a different surface (such as a wall 697 of an oppositely-positioned guide plate of the receptacle portion 652) will be received. In either case, a certain amount of time will have elapsed after transmission of the signal 691b that will indicate that there is not a sufficient level of paper plates 605b present within the receptacle portion 652. Such sensor data may be communicated to the system for use therein, such as for determining an amount of paper plates present in the paper plate holder 650 and/or for inventory control. Notably, although not shown, different and/or additional types of sensors may be utilized with the contemplated paper plates holder 650 (e.g., weight based sensors, infrared sensors, etc.). For example, positioning another sensor at a different vertical position may provide a further threshold level that may correspond to an amount of consumable product remaining.

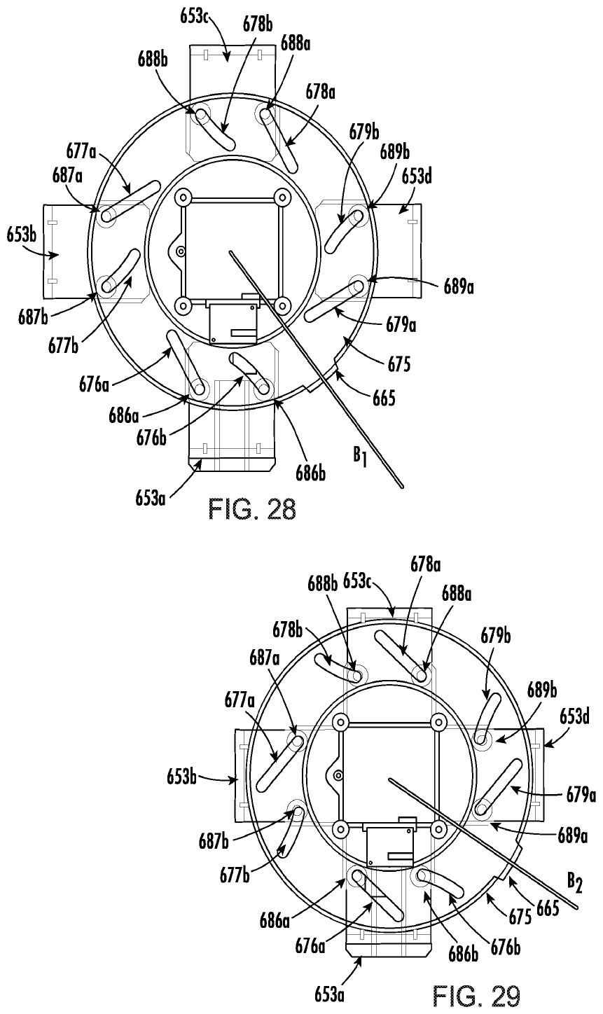

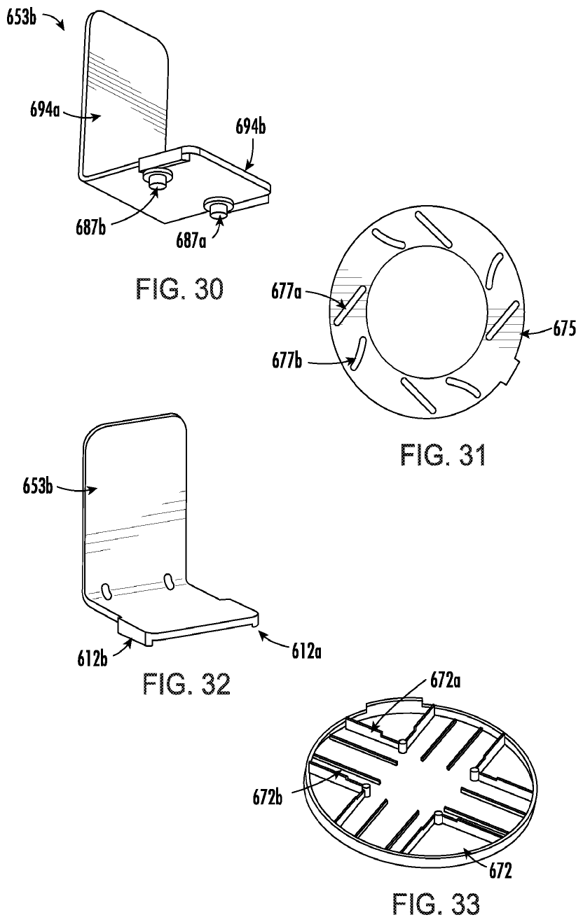

In some embodiments, the paper plate holder 650 may be configured to adjust the size of the receptacle portion 652 so as to receive a supply of differently sized plates. For example, with reference to FIGS. 25 and 30, each guide plate, such as guide plate 653b includes a vertical portion 694a and a base portion 694b. The base portion 694b of each guide plate may be sandwiched with a cam plate 675 between a top plate 676 and a bottom plate 672—thereby forming the base portion 654 of the paper plate holder 650. Notably, with reference to FIGS. 25, 28, and 29, the base portion 654 may include a movable button 665 that is movable between a first position corresponding to the guide plates 653a-d being in an expanded state (shown in FIG. 28) and a second position corresponding to the guide plates 653a-d being in a compressed state (shown in FIG. 29). In this regard, the angular direction of the button 665 is denoted as B₁ or B₂—thereby showing the different positions. In some embodiments, the button 665 and/or guide plates may be biased to a certain position, such as to be sized for the smallest plate size contemplated.

With reference to FIGS. 28-31, each guide plate may include two guide pins (e.g., guide plate 653b includes guide pins 687a, 687b). The guide pins are slidably positioned within a corresponding guide slot (e.g., 677a, 677b) of a cam plate 675. With reference to FIGS. 28-29, guide plate 653a includes guide pins 686a, 686b that slidably fit within guide slots 676a, 676b, respectively; guide plate 653b includes guide pins 687a, 687b that slidably fit within guide slots 677a, 677b, respectively; guide plate 653c includes guide pins 688a, 688b that slidably fit within guide slots 678a, 678b, respectively; and guide plate 653d includes guide pins 689a, 689b that slidably fit within guide slots 679a, 679b, respectively. Notably, each guide slot is shaped to guide sliding movement of the corresponding guide pin so as to force lateral movement of the corresponding guide plate. In this regard, with reference to FIGS. 32 and 33, the guide plates include ledges (e.g., guide plate 653b includes ledges 612a, 612b) that slidingly engage corresponding wall tracks 672a, 672b of the bottom plate 672. Thus, when assembled together, a user may operate the button 665 such as from direction B₁ (FIG. 28) to various positions leading to direction B₂ (FIG. 29) to cause rotation of the cam plate 675 which thereby forces lateral movement of the guide plates 653a-d so as to cause the space 657 that receives the plates to define different-sized diameters, thereby enabling receipt of differently-size plates therein.

In some embodiments, the button 665 may be biased (e.g., via a spring) to the position shown in FIG. 29, such as to ensure proximity of the consumable product and the sensor is appropriately correlated. Additional embodiments that utilize a bias to accomplish an appropriate relationship between the sensor and the consumable product may be conceived for each type of tracking device, such as any tracking device stated herein as an example. Some may move the sensor toward the consumable product and/or move the consumable product toward the sensor.

### Example Bulk Storage Product Holder

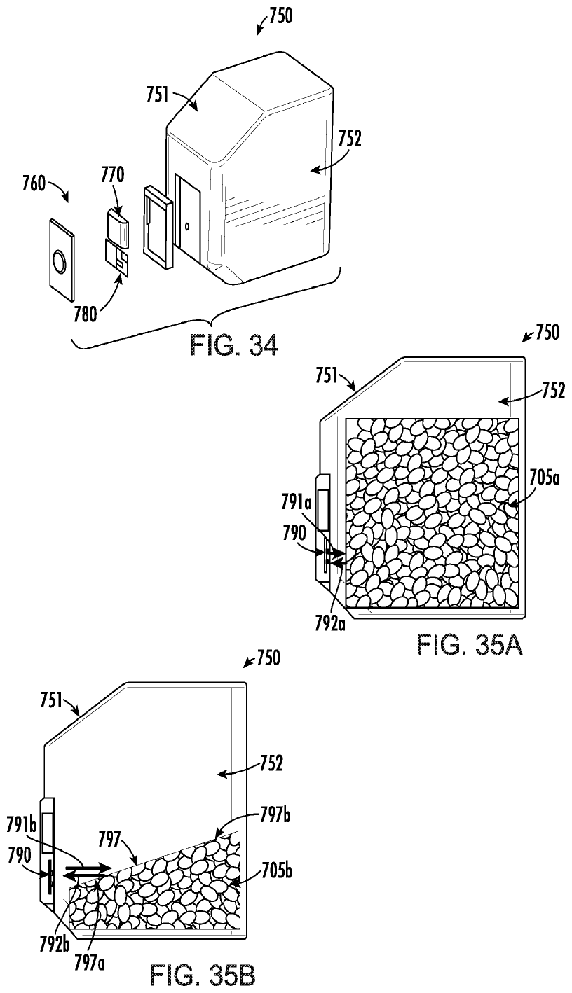

In some embodiments, a bulk storage product holder (e.g., for bulk storage product, such as pet food, cereal, candy, flour, batteries, coffee, nails, etc.) is contemplated for use with various tracking and re-order systems described herein. FIG. 34 illustrates an example bulk storage product holder 750 for holding and tracking a supply of bulk storage product. In the illustrated embodiment, the bulk storage product holder 750 includes a receptacle portion 752 that includes a space defined therein for receiving a supply of bulk storage product. A lid 751 can be used to access the receptacle portion 752, such as to remove or add bulk storage product. A sensor module 760 is positioned adjacent one of the walls of the receptacle portion 752 and includes a sensor 790 configured to determine the presence or absence of the bulk storage product at a certain level within the receptacle portion 752. Additionally, the bulk storage product holder 750 may include a controller and/or a communication interface, such as on a printed circuit board 780 housed in the sensor module 760. The communication interface may be capable of transmitting the sensed data from the sensor 790 to a remote device. Notably, one or more batteries 770 may also be stored in the sensor module 760 (or other portion) and provide power to the various components/features of the bulk storage product holder 750.

With reference to FIGS. 35A-35B, the sensor 790 may be placed at a vertical position in the receptacle portion 752 that corresponds to determination of a desired threshold amount of bulk storage product in the receptacle portion 752. In this regard, the sensor 790 may be configured to transmit a signal 791a at the vertical position across the receptacle portion 752 so as to be directed toward the supply of bulk storage product 705a. If a sufficient amount of bulk storage product is in the supply 705a (such as shown in FIG. 35A), the signal 791a will reflect off the bulk storage product and form a return signal 792a that will be received at the receiver of the sensor 790. In such a manner, the sensor 790 may detect the presence of the supply of bulk storage product 705a at the threshold level within the receptacle portion 752.

In some embodiments, the sensor 790 may be a time-of-flight sensor that provides time stamps associated with the signals 791a, 792a so as to enable determination that a time period that has elapsed between transmitting the signal 791a and receiving the return signal 792a is within a threshold time period—thereby indicating that a level of bulk storage product 705a is present in the receptacle portion 752. However, if an insufficient level of bulk storage product 705b is present in the receptacle portion 752 (such as shown in FIG. 35B), then either no return signal will be received or a return signal 792b that reflects off some remote portion of the bulk storage product (e.g., 797) or a different surface (such as an opposite wall of the receptacle portion 752) will be received. In any case, a certain amount of time will have elapsed after transmission of the signal 791b that will indicate that there is not a sufficient level of bulk storage product 705b present within the receptacle portion 752. Such sensor data may be communicated to the system for use therein, such as for determining an amount of bulk storage product present in the bulk storage product holder 750 and/or for inventory control. Notably, although not shown, different and/or additional types of sensors may be utilized with the contemplated bulk storage product holder 750 (e.g., weight based sensors, infrared sensors, etc.). For example, positioning another sensor at a different vertical position may provide a further threshold level that may correspond to an amount of consumable product remaining.

In some embodiments, such as utilizing a time-of-flight sensor, the amount of time that has elapsed from transmitting the signal 791b to receiving the return signal 792b can be used, such as by a controller, to determine/estimate the amount of bulk storage product 705b within the receptacle portion 752. In this regard, since the bulk storage product may be loose within the receptacle portion 752, the level of the bulk storage product may not be uniform, such as having a top that is higher in the back 797b of the receptacle portion 752 than the front 797a. Thus, the amount of time that has elapsed between transmission of signal 791b and receipt of return signal 792b may correlate to the amount of bulk storage product within the receptacle portion 752. In this regard, a formula and/or look-up table could be prepared that provides an estimate as to the amount of bulk storage product within the receptacle portion 752 based on the time the elapses from transmission of signal 791b to receipt of return signal 792b—which may be provided to the remote device for use with various tracking and re-order systems described herein.

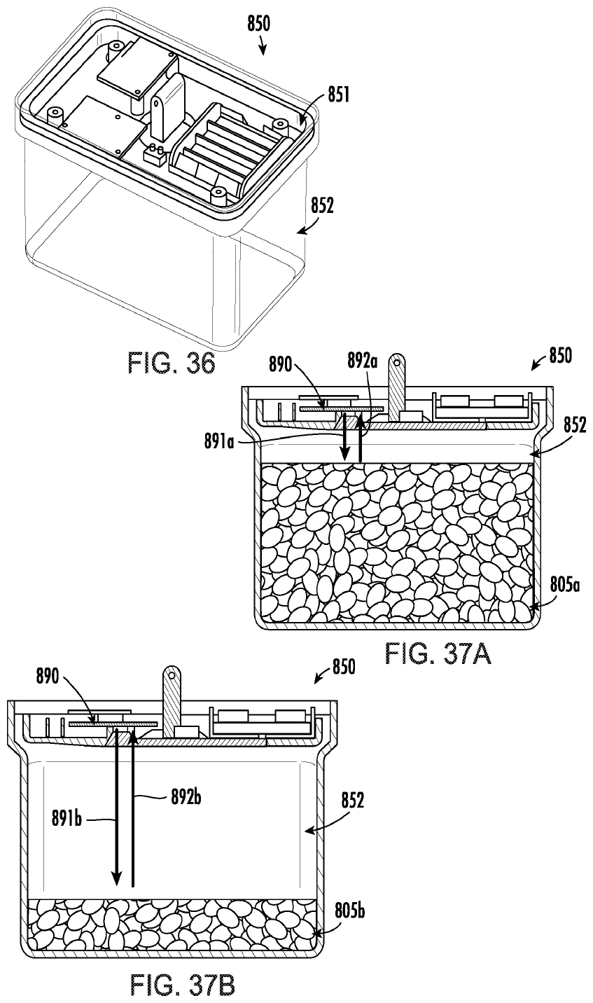

In some embodiments, the sensor may be oriented to transmit a signal vertically down into the receptacle portion. In this regard, the time that has elapsed from transmitting the signal and receiving the return signal may be used to estimate the amount of bulk storage product in the receptacle portion—such as similar to that described herein with respect to FIGS. 35A-B. FIGS. 36, 37A, and 37B illustrate an example bulk storage product holder 850 that includes a lid 851 and a receptacle portion 852. A sensor 890 is positioned on the lid 851 and configured to transmit a signal downwardly into the receptacle portion 852 and receive a return signal therefrom. With reference to FIG. 37A, the sensor 890 may transmit a signal 891a which may reflect off the bulk storage product 805a and be received by the sensor 890 as return signal 892a. The relatively short time period that elapsed may be determined and used (such as by a controller of the holder 890 or a remote device) to determine/estimate the amount of bulk storage product within the receptacle portion 852. In this regard, FIG. 37B illustrates that less bulk storage product 805b will cause a longer amount of time to elapse between transmission of the signal 891b and receipt of the return signal 892b—thereby indicating less bulk storage product 805b being within the receptacle portion 852.

In some embodiments, other sensor arrangements may be utilized. For example, the time-of-flight sensor may be angled into the container, such as downwardly and into the container from an upper corner or side. This may provide a more accurate reading. In some embodiments, two or more time-of-flight sensors, each positioned to emit and receive signals to and from a different portion of the container may be used to create a more accurate reading.

In some embodiments, other types of sensors may be utilized. For example, a camera may be utilized with image recognition technology to determine the amount of consumable product remaining. In some embodiments, sonar or radar may be utilized. In some embodiments, a weight-based sensor may be positioned beneath the consumable product and used to measure the amount of consumable product remaining. In some embodiments, two different types of sensors may be utilized to provide a double check system.

In some embodiments, the device may include a “push to reorder” button. For example, the device may include a button thereon that enables a user to simply push the button, which causes initiation of a re-order for the correlated consumable product.

### Other Example Tracking Devices and Sensor Embodiments

In addition to the above noted devices, other household item devices are contemplated, such as a “placemat” for bathroom essentials, jars for bathroom and kitchen essentials. In such example devices, one or more sensors or other features as described in other devices herein may be utilized, such as a weight-based sensor.

Further additional tracking device embodiments, system features, and other related functionality that may be utilized with various embodiments described herein are described in U.S. Provisional Application No. 62/912,751, which was filed Oct. 9, 2019, entitled “Systems and Methods for Inventory Tracking of Sheet Product Rolls”, which is incorporated herein in reference in its entirety.

### Example Software Application(s)

Some embodiments of the present invention provide a software application, such as may be usable with various tracking and re-order systems described herein. In this regard, the software application may be stored on a user's mobile or other device (e.g., in the memory of the user's device) and usable to interact with and/or control functionality of such example tracking and re-order systems. As noted herein, the software application may interact with, such as via various communication protocols, various devices and components of the tracking and re-order system—such as various tracking devices, remote devices, smart hub, etc.

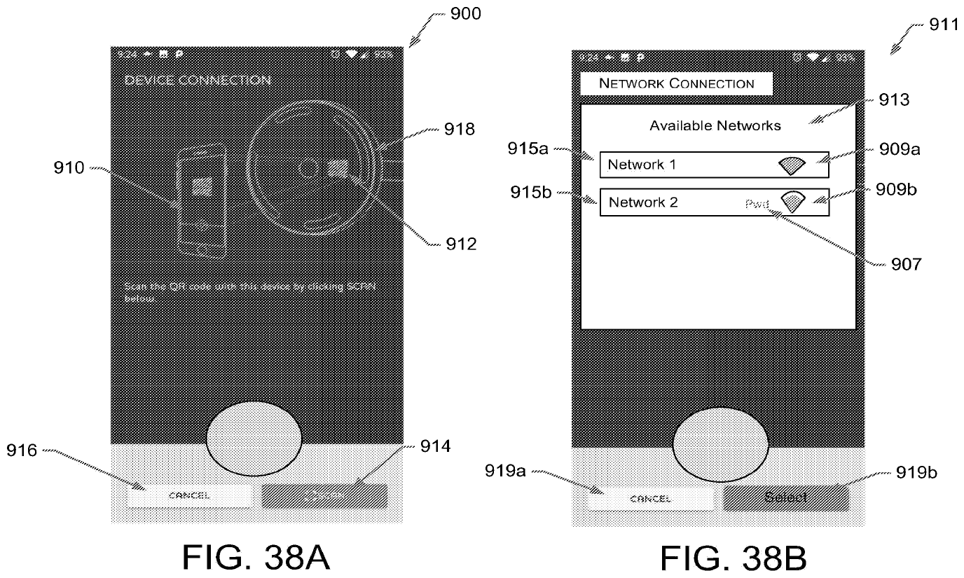

FIGS. 38A-52 illustrate example screens of user interfaces for example embodiments of a software application that enables and provides various functionality to a user corresponding to the tracking and re-order systems described herein.

FIG. 38A illustrates an example screen 900 of a user interface that enables a user to connect a tracking device to the tracking and re-order system. When a user obtains a tracking device (such as one of the tracking devices described herein), the user may utilize the software application to commission or add the tracking device to the household environment. This will cause the sensor data from the tracking device to be utilized in the tracking and re-order system for the relevant consumable product for the household environment. The screen 900 provides an illustration of a user's mobile device 910 being used to capture an image of a Quick Response (“QR”) Code 912 on the tracking device 918. Based on these instructions, the user may act accordingly to capture an image of a QR Code for the tracking device, which may then link the tracking device with the software application and the user's account (and, thus, there household environment). Accordingly, the user may press the “Scan” button 914 to initiate the scan for the QR Code or the “Cancel” button 916 to cancel the action.

In some embodiments, the software application may be configured to self-discover one or more tracking devices, such as within BLE range that are of the correct type. This approach may provide less setup and registration time for the tracking devices and an easier user experience. Additionally, other configuration options may be provided, such as enabling a user to enter details of a tracking device.

In some embodiments, the software application may be configured to help a user select a local network for use by the tracking device to connect to an external network. In some cases, certain local networks may be better suited for the tracking device (e.g., as opposed to the user's device). This could be due to the different locations of the tracking device versus the user's device and/or due to different wireless capabilities (e.g., the user's device may be configured to work with a different wireless network). In some embodiments, the software application may enable identification and registration of a local network through one or more commissioning options, such as manual commissioning, automatic user device commissioning, and/or automatic tracking device commissioning.

In some embodiments, the software application may be configured to enable manual commissioning. For example, the user may manually enter various details regarding the local network the tracking device should use for connection. For example, the user may enter the network name, network security type, and/or the network security password. This information may then be passed to the tracking device (e.g., via a direct wireless connection between the user device and the tracking device, such as BLE, although WiFi could also be used) for utilization by the tracking device. In some embodiments, the tracking device may store the network information in non-volatile memory such that the information won't be lost if a power loss occurs.

In some embodiments, the software application may be configured to enable automatic user device commissioning. For example, the user device may identify available local networks for itself. The user may then select the desired available network and that information may be passed to the tracking device for use (an example screen illustrating available networks is shown in FIG. 38B—although the way that information is gathered and the corresponding signal strength is different depending on which commissioning approach is utilized). In some embodiments, one or more sets of information (e.g., the network password) may still be needed. In such example embodiments, it may be assumed that the user device is proximate to the tracking device such that the available networks are similar between the two. In some embodiments, the user device may take into account certain capabilities of the tracking device and may, for example, filter out any networks that are not usable by the tracking device. In some embodiments, the user may be able to specify the number of listed available networks (e.g., limit it to 3 networks to choose from, such as the three with the strongest signal strength).

In some embodiments, the software application may be configured to enable automatic tracking device commissioning. For example, FIG. 38B illustrates an example screen 911 of a user interface that enables a user to select an available local network (e.g., a WiFi network) for the tracking device to utilize for connecting to an external network (e.g., a remote server, etc.). In this regard, the tracking device may be configured to gather available network information regarding available networks that it could connect to. That available network information may be passed to the user's device to enable selection of which network to utilize for the tracking device. For example, screen 911 includes a listing of available networks 913 identified by the tracking device. In the illustrated example, there are two network options: Network 1 915a and Network 2 915b. The screen 911 may also indicate the signal strength of the network based on where the tracking device is located (e.g., as opposed to the signal strength of the network based on where the user's device is). For example, Network 1 915a has a signal strength illustrated by the icon 909a that is filled up, whereas Network 2 915b has a signal strength that is less than full as indicated by the icon 909b (which is not fully filled up). The screen 911 may also indicate whether the available network is password protected, as indicated by “Pwd” 907 for Network 2 915b. Notably, other icons or indicators are contemplated for the various features. Once a user indicates a desired network, they can select the “Select” button 919b or they can cancel the action by selecting the “Cancel” button 919a. Depending on the desired configuration, in some embodiments, the tracking device may be configured to check for available networks in the background (e.g., continuously or once initial contact with the user device is initiated). Additionally or alternatively, the software application may send instructions to the tracking device to cause initiation of the search. In some embodiments, the user may be able to specify the number of listed available networks (e.g., limit it to 3 networks to choose from, such as the three with the strongest signal strength).

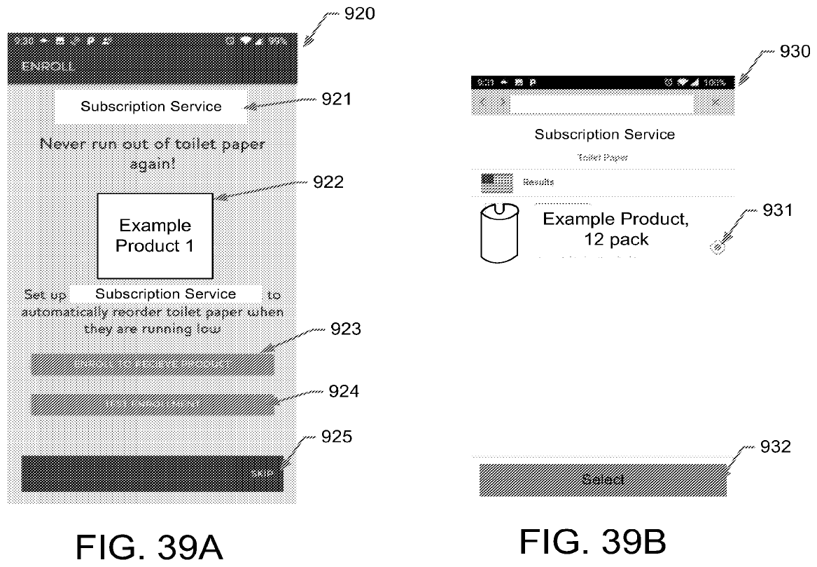

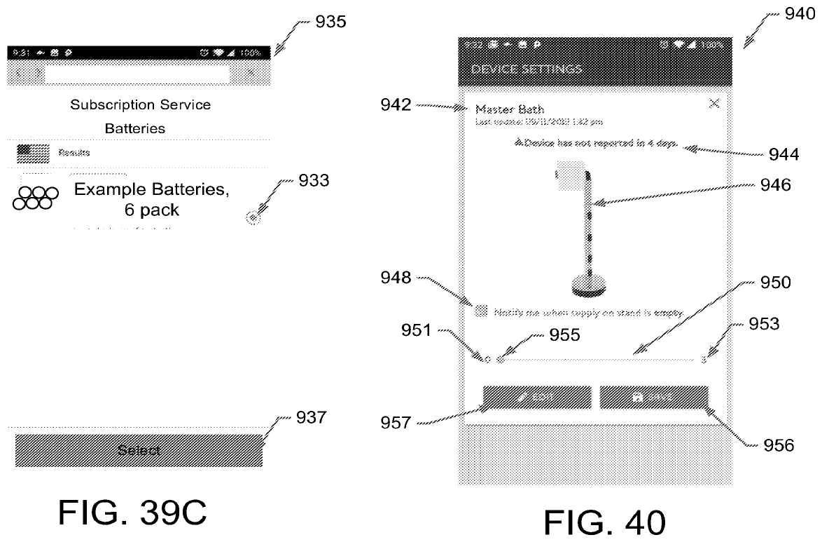

FIG. 39A illustrates an example screen 920 of a user interface that enables a user to enroll in a subscription service or other replenishment service for ordering new consumable product. In this regard, in some embodiments, the tracking and re-order system may work with an external subscription or reorder service for various consumable product (e.g., an online subscription/reorder service). As described herein, once the tracking and re-order system determines that the household environment inventory re-order threshold is met, the system may provide the user an opportunity to place an order using the previously set-up online order—such as through the subscription or reorder service.

Returning to FIG. 39A, the screen 920 includes an indication of the selected subscription service 921 and may include a visualization 922 of the consumable product (e.g., toilet paper) that is set-up for re-order ability. Option 923 allows the user to enroll in the subscription service and option 924 may allow testing of enrollment. Option 925 allows the user to skip enrollment in a subscription service. Under this option, the software application may simply notify a user when the product is below a threshold—thereby enabling a user to manually order more consumable product.

FIG. 39B illustrates an example screen 930 of a user interface that enables a user to select a consumable product order option for use with the subscription service or other replenishment service. The screen 930 may present various order options, such as may correspond to one or more brand options and one or more amount options (6-pack, 12-pack, 24 oz., etc.) all depending on the type of consumable product and the available order options for the chosen subscription or reorder service(s). The screen 930 in FIG. 39B illustrates that a user has indicated a desire 931 to receive a 12-pack order of the “Example Product” brand of toilet paper as the stored online order. The user may now hit “Select” 932 to set that order for later use.

Notably, a user may sign up for multiple different order options through the same or different subscription or reorder services. In some embodiments, the system may compare available pricing for each preset order option and choose the best available when placing an order. In some embodiments, user preferences may be accounted for in the decision as to which order option to use. In some embodiments, upon initiation of re-order functionality, the user may be presented with available order options for selection by the user.

In some embodiments, the tracking and reorder system may be configured to enable tracking and reorder functionality for batteries that are used to power the various tracking devices. In some such embodiments, the tracking devices may be configured to monitor their battery level and report that to the tracking and reorder system. Once the battery level is below a threshold level, then re-order functionality may be implemented (such as various types of re-order functionality described herein). FIG. 39C illustrates an example screen 935 of a user interface that enables a user to select a battery reorder option for use with the subscription service or other replenishment service. The screen 935 may present various order options, such as may correspond to one or more brand options and one or more amount options (6-pack, 12-pack, etc.). In some embodiments, the tracking device may “know” the type of battery needed and provide that information to the tracking and reorder system for automatic selection of the appropriate battery type (e.g., “AA” batteries, “D” batteries, etc.). The screen 935 in FIG. 39C illustrates that a user has indicated a desire 933 to receive a 6-pack order of the “Example Batteries” brand as the stored online order. The user may now hit “Select” 937 to set (e.g., save) that order for later use.

FIG. 40 illustrates an example screen 940 of a user interface that enables a user to select settings corresponding to a tracking device that is part of the tracking and re-order system. The screen 940 includes an indication of the selected tracking device, illustrated as the “Master Bath” tissue stand 942. The screen 940 may include notifications such as may require a user's attention—e.g., the “Device has not reported in 4 days.” 944. In response, the user may perform maintenance or other action with respect to the tracking device. The screen 940 may also includes a visualization of the tracking device 946. Further, the user may select an option 948 to be notified when the supply on the specific tracking device (or a portion thereof—such as the stand portion) is empty. This may be in addition to the overall inventory tracking/reorder functionality that occurs.

Screen 940 may also include an option for a user to select the threshold amount of consumable product on the tracking device that will cause initiation of re-order functionality. In the illustrated embodiment, a user can move a marker 955 along a track 950 to select a number between “0” 951 and “3” 953—which may correspond to the number of dispensing or reserve positions for the consumable product being monitored by the tracking device (although it could be less than the full number of dispensing or reserve positions). Once selected, the user may select “Save” 956. Alternatively, the user can further “Edit” 957 the device settings.

FIG. 41 illustrates an example screen 960 of a user interface that provides a user with the statuses of various tracking devices and, if used, the extra inventory tracking that are part of the tracking and re-order system. Line 961 indicates that the user has 2 devices linked to their account. Line 962 indicates that one of the devices needs attention, such as it may be out of or low on consumable product, may not be connected to an external network, and/or may require maintenance of some kind. The first device is indicated as “Tissue Stand BBDF8” at 964a and includes a visual image of toilet paper to show the type of consumable product being tracked via the device. To the right of that are various icons 965a indicating information about the corresponding device 964a. For example, the icon of the toilet paper with a red line across it indicates that the device is empty and the green full battery icon indicates that the battery life of the device is close to full. The second device is indicated as “Master Bath” at 964b and includes a visual image of toilet paper to show the type of consumable product being tracked via the device. To the right of that are various icons 965b indicating information about the corresponding device 964b. For example, a red triangle icon indicates that attention is needed for the device, an icon of four toilet paper rolls indicates that the device has product installed (such as four toilet paper rolls), and the green full battery icon indicates that the battery life of the device is close to full.

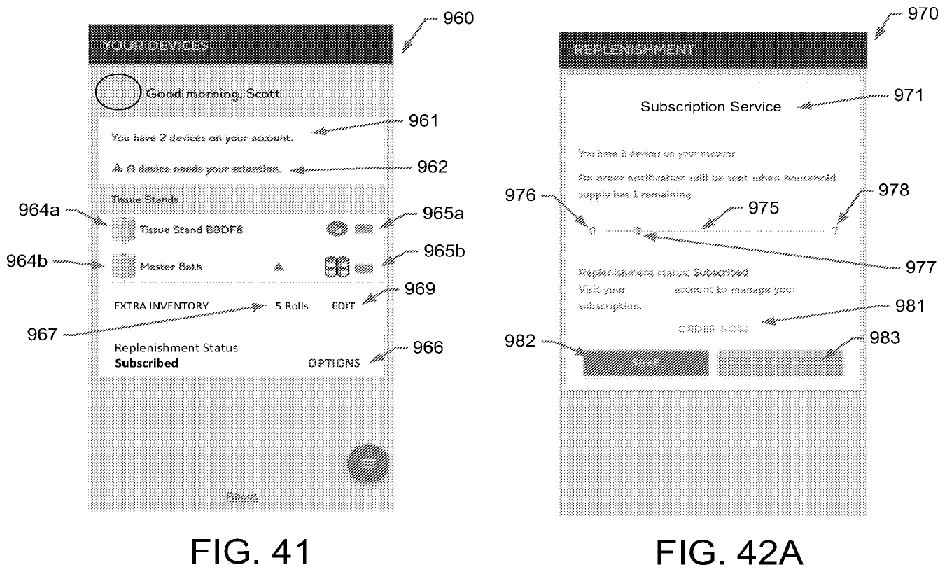

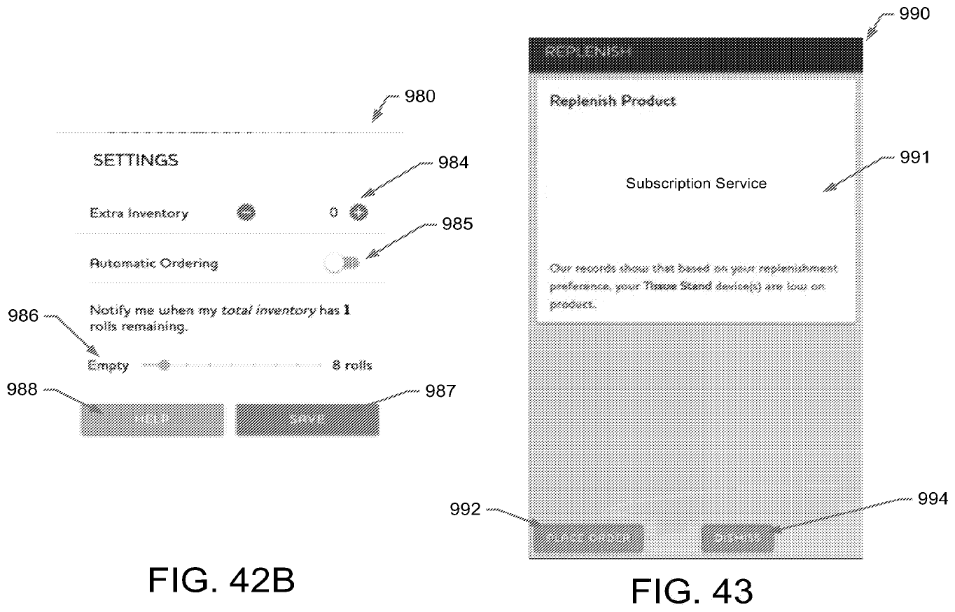

In some embodiments, the tracking and reorder system may also enable tracking of “extra inventory”. In this regard, a user may store extra inventory that does not fit on the one or more tracking devices (e.g., the user may store the inventory in one or more places in their home). For example, a user may purchase a 12-pack of tissue rolls, but only have room to put 7 of the tissue rolls on their utilized tracking devices, leaving 5 rolls remaining. The user may input that amount (e.g., “5 Rolls”) as extra inventory (e.g., such as described with respect to the screen 980 illustrated in FIG. 42B). The number of rolls (e.g., “5 Rolls” 967) in the “Extra Inventory”) are indicated on the screen 960, and there is an option to “Edit” 969 that number.

In some embodiments, the extra inventory may be automatically updated depending on various events that occur within the tracking and reorder system. For example, upon a tracking device updating to include a new number of rolls (such as due to the user positioning a new replacement roll on a tracking device and the tracking device sensing the new roll), the extra inventory may be updated (e.g., decremented) accordingly. In some embodiments, the tracking and reorder system may update the extra inventory based on received orders from the subscription service (e.g., based on an actual receipt of delivery, based on an estimated delivery date, etc.). For example, once the ordered 12-pack arrives, the extra inventory may be updated to indicate the addition of 12 rolls. Thereafter, the extra inventory may be further updated once the rolls are placed on the tracking devices (and those new rolls are sensed on the tracking devices accordingly).

Returning to FIG. 41, line 966 indicates that the account is enrolled in a subscription or reorder service, and provides options for editing that service.

FIG. 42A illustrates an example screen 970 of a user interface that enables a user to set the threshold for a household inventory that corresponds to when to initiate re-order functionality utilizing the tracking and re-order system. Line 971 indicates the applicable subscription or reorder service. Screen 970 includes an option for a user to select the threshold amount of consumable product for the household environment that will cause initiation of re-order functionality. In the illustrated embodiment, a user can move a marker 977 along a track 975 to select a number between “0” 976 and “7” 978—which may correspond to the number of dispensing or reserve positions for the consumable product being monitored by all of the tracking devices linked to the user's account (e.g., both devices shown on screen 960 in FIG. 41). Screen 970 also allows a user to initiate an order via the subscription or reorder service by selecting option 981. A user can also “Save” 982 or “Close” 983 the screen 970 accordingly.

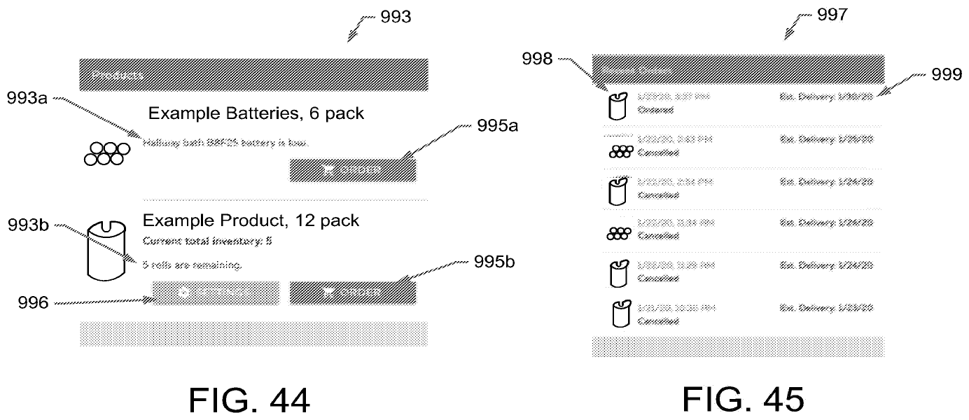

FIG. 42B illustrates another example screen 980 of a user interface that allows a user to input various options for the tracking and reorder system. In some embodiments, the screen 980 may display as a pop-up screen in response to selection of a corresponding option by the user. At 984, the user may indicate the “Extra Inventory” level for the tracking and reorder system. At 985, the user may set the type of reorder functionality desired for the consumable product. For example, by enabling “Automatic Ordering”, the tracking and reorder system may be configured to automatically place the subscription order upon the threshold requirement being met. If disabled, instead, the user may simply receive a notification of the threshold requirement being met (thereby allowing the user to go in and order more product, such as using the “Order” option shown in FIG. 44). At 986, the user may indicate the desired threshold level of consumable product remaining (e.g., number of tissue rolls) for the total (e.g., household) inventory (e.g., on the tracking devices and in the extra inventory) that triggers the desired reorder functionality. Accordingly, the user may “Save” at 987 the selections or may select “Help” at 988 to be offered assistance—such as through an external webpage, placing a call to customer service, etc.

FIG. 43 illustrates an example screen 990 of a user interface that enables a user to place an order for more consumable product, such as may be provided to the user in response to a household inventory threshold being met. Once the tracking and re-order system determines that the household inventory re-order threshold is met, the system may provide the user an opportunity to place an order 992 using the previously set-up online order—such as through the subscription or reorder service 991. By selecting the “Place Order” button 992, the software application may initiate an online order based on a previously stored online order with the subscription or reorder service. This provides an easy reorder option that still provides the user with the option to control the reorder, such as to prevent over ordering. In this regard, in the alternative, the user may select “Dismiss” 994, such as if the user would like to handle ordering separately or if the notification was not proper. For example, the user may have additional consumable product in the household environment that was unaccounted for via the software application. Once the user positions the consumable product on the tracking device(s) the software application will detect it and reset accordingly.

FIG. 44 illustrates an example screen 993 of a user interface that provides information regarding, for example, current inventory of a tracked consumable product and current battery level for the batteries of one or more tracking devices for the tracking and re-order system. For example, the screen 993 may indicate the tracked products and provide an indication of the saved subscription order and the corresponding, for example, current battery level or current inventory amount. For example, the saved battery order option and a “low” battery level for the Hallway bath tracking device is indicated at 993a for batteries, and the saved tissue roll order option and an indication of 5 rolls remaining is indicated at 993b for the tissue rolls. Additionally, the option to initiate an “Order” 995a, 995b is available for each tracked product. Further, a “Settings” option 996 is available for the user to select to make various updates to the system, such as with respect to one or more of the products.

FIG. 45 illustrates an example screen 997 of a user interface that shows recent orders that have been placed for the tracking and re-order system. For example, the product ordered is indicated at 998 and the estimated delivery date is indicated at 999. In some embodiments, the status of the order (e.g., ordered, shipped, canceled, etc.) may be indicated. Once delivered, in some embodiments, the delivery date may be updated accordingly.

In some embodiments, the software application may be configured to provide other notifications/functionality to a user. For example, the following lists some example notifications:
i. When product falls below a specified level in a tracking device.
ii. When a tracking device part or consumable is defective or needs replacement (e.g., batteries, lost paper towel holder (e.g., “collar”), etc.).
iii. When the tracking device has not reported to the remote device within a specified time.
iv. When an order has been placed, shipped, and/or delivered.
v. Notify the user when specified time has elapsed since the order was placed.
vi. Notify the user when a specified time has elapsed since the low product notification.
vii. Notify the user when a specified time has elapsed that the device has been in a continual state of low product.
viii. When a low product level notification has been delayed or shelved.
ix. In some cases, such as with an example tissue stand, users can be notified when the amount of product falls below a specified device level value, or when the combined amount of product across all tracking devices of a type (which may include any “extra inventory”) falls below a specified limit. In some embodiments, logic of this type can be applied to any series of sensors working together to measure inventory or product consumed.
x. When a sensor or logic detects an error with a tracking device.

As detailed herein, in some embodiments, the software application may apply various factors in determining re-order and tracking functionality. For example, the software application can factor in the anticipated delivery time of consumable products, minimum desired levels, monitored or inputted consumer usage patterns, preferred minimum product quantity sizes, or other factors. In some embodiments, the software application may determine and provide consumable product “ahead of time” or for the “extra inventory”.

In some embodiments, the software application may allow a user the ability to pick and choose which tracking devices and/or which consumable products are enabled for re-order functionality. In some embodiments, the type of re-order functionality (e.g., manual, semi-automatic, automatic) may be selected for each tracking device and/or consumable product.

In some embodiments, the software application may provide consumer incentives based on program participation, or the number of automatic or manual retail orders placed. In this manner, users can be rewarded (through financial or other incentives) for purchases through the system. In some cases, the reward may include volume discounts being applied.

In some embodiments, the software application may allow for or factor in incentives or customer preferences for which order is placed, such as in conjunction with the re-order functionality. For example, consumers can select their fulfillment channel or retailer from the available choices based on retailers who may participate in various such programs (including, for example, an incentive program for the software application), and replenishment consumable products (including quantity and size) can be selected from available products in the software application for that retailer.

Similarly, as detailed herein, in some embodiments, other factors, such as lowest cost or best value or best rated product may be accounted for when recommending or selecting an order option.

In some embodiments, the software application can capture and provide the user with data on past purchases, such as may include time frames of the purchases, amount, pricing, etc. This can give the user perspective on the time frames since the last purchase and amount purchased to allow the user to use that data to determine if the replenishment order is appropriate.

In some embodiments, the software application can capture and provide the user with data concerning past consumption of consumable products from each tracking device over specified time ranges. This can give the user perspective on usage of a consumable product in the household environment to help determine if they are ordering too much or too early, for example.

In some embodiments, the software application can allow users to create a shopping cart of items, which may allow users to save items identified for replenishment by the tracking devices in a bulk order. This order can be stored on the software application and released manually by the user later for fulfillment by a specified retailer. In an example embodiment, the order can be released after a specified time (e.g. 2 days).

In some embodiments, the software application can allow users to add additional products not identified by the tracking devices to a shopping list for a specific retailer. This may allow users to add products not tracked by tracking devices to a shopping list of items tracked by tracking devices—thereby potentially saving time and/or shipping costs.

In some embodiments, the software application can identify which items on a shopping list were specifically flagged for replenishment from each specific tracking device. This may allow the user to determine which replenishment orders were derived from tracking devices vs. added manually by the user.

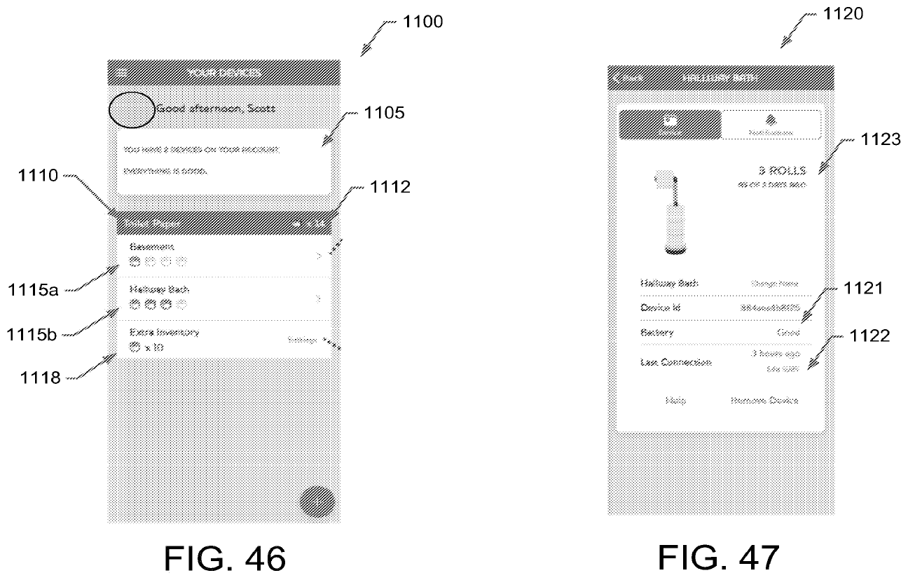

FIGS. 46-52 illustrate additional example screens of a user interface for example embodiments of a software application that enables and provides various functionality to a user corresponding to the tracking and re-order systems described herein. Notably, such example screens include much of the above described functionality and features and some such features and functionalities may not be re-described below.

FIG. 46 illustrates an example screen 1100 of a user interface that shows a general system level view of a user's inventory tracking and re-order system. The screen 1100 illustrates an overall message section 1105 that details the status of the system and the number of linked devices. If there are situations that require attention, such a corresponding message may be displayed in this section. The screen 1100 also provides a section 1110 detailing different consumable product that is tracked (and there may be multiple types as described herein, each with their own devices and extra inventory). Here, toilet paper is being tracked and the total inventory in the environment is noted in the upper right at 1112 (e.g., 14 rolls). The section 1110 also displays clickable description of the devices (e.g., the basement device 1115a and the hallway bath device 1115b); as well as the extra inventory amount 1118.

FIG. 47 illustrates an example screen 1120 of a user interface that shows a detail view of a device (e.g., the “Hallway Bath” device) used in an inventory tracking and re-order system. Such a screen 1120 may be navigated to after clicking on the corresponding user input in the prior screen 1110. In this screen 1120, a user may control various functionality and features regarding the hallway bath device and view corresponding status of the same. For example, it shows the battery condition at 1121 and when the last connection was at 1122. It also displays the number of rolls stored on the device.

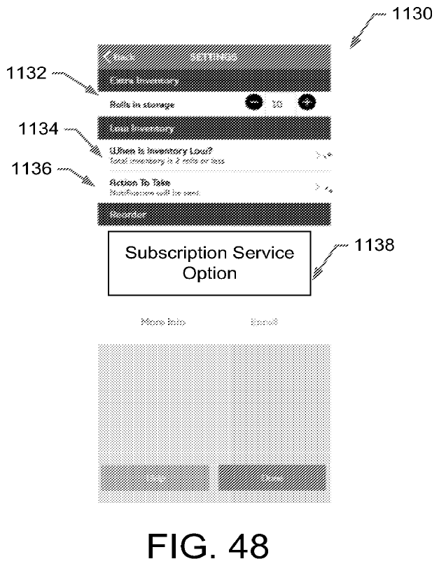

FIG. 48 illustrates an example screen 1130 of a user interface that enables a user to adjust settings for the tracking and re-order system. Such a screen 1130 may be navigated to after clicking on the corresponding user input in the prior screen 1110 (e.g., a “Settings” button or the “Extra Inventory”). The screen 1130 includes an Extra Inventory section 1132 that enables a user to adjust the amount of extra inventory in their environment. The screen 1130 also includes a section 1134 for allowing the user to navigate to a screen where they can input when re-order functionality should occur (e.g., adjust the threshold amount of inventory that triggers re-order functionality). The screen 1130 also includes a section 1136 that allows a user to navigate to a screen where they can adjust the type of re-order functionality that is applied for that consumable product type once the threshold inventory amount is reached. Further, the current threshold amount and action to take are shown on this screen 1130. The screen 1130 further includes an indication of whether automatic ordering is enabled through a subscription service at section 1138.

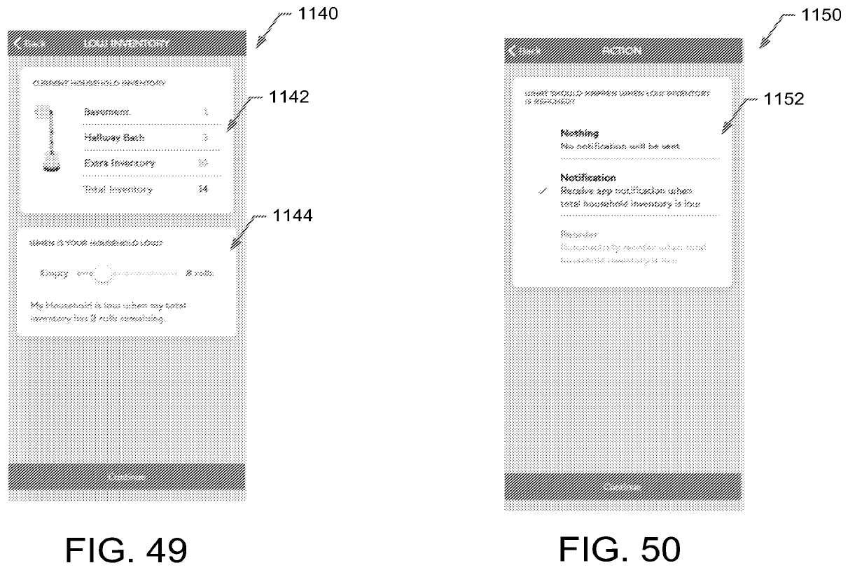

FIG. 49 illustrates an example screen 1140 of a user interface that enables a user to adjust a setting regarding when the inventory of the consumable product is considered low for initiating re-order functionality. Such a screen 1140 may be navigated to after clicking on the corresponding user input in the prior screen 1130 (e.g., the section 1134 “When is Inventory Low”). Screen 1140 includes a first section 1142 that illustrates a breakdown of the number of rolls (or consumable product) on each device and in extra inventory—including showing the total inventory in the environment. A second section 1144 allows a user to adjust the threshold amount of inventory in the environment that triggers re-order functionality.

FIG. 50 illustrates an example screen 1150 of a user interface that enables a user to set the desired re-order functionality for when the inventory is considered low. Such a screen 1150 may be navigated to after clicking on the corresponding user input in a prior screen 1130 (e.g., the section 1136 “Action To Take”). The screen 1150 includes a section 1152 that allows the user to select which re-order functionality to apply once the threshold amount of inventory in the environment is reached. In the illustrated embodiment, the “Reorder” function that automatically initiates a preset order is greyed out because there is no linked subscription service with a viable automatic order option for the tracked consumable product.

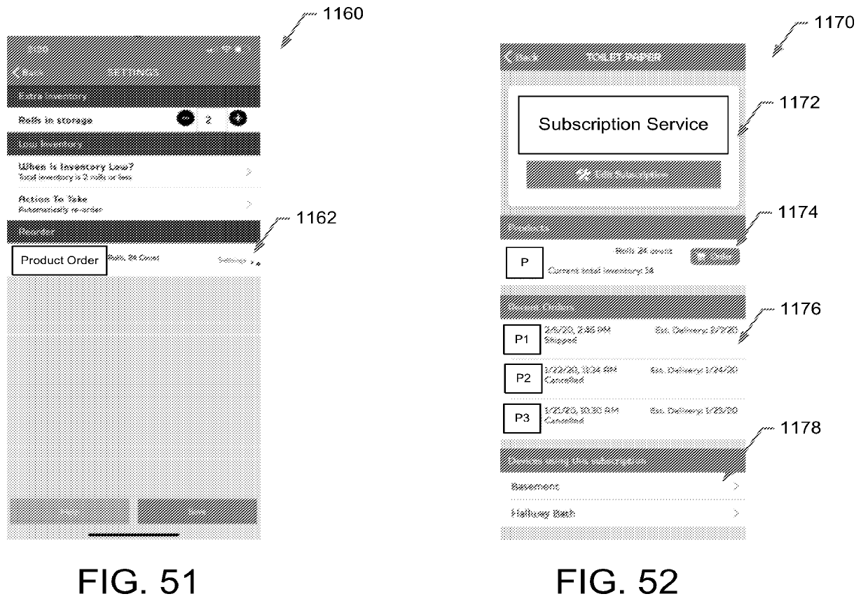

FIG. 51 illustrates an example screen 1160 of a user interface that enables a user to adjust settings for the tracking and re-order system. This screen 1160 is similar to screen 1130, but shows that a subscription service 1162 is linked to the tracked consumable product.

FIG. 52 illustrates an example screen 1170 of a user interface that shows details regarding the enrolled subscription service. Such a screen 1170 may be navigated to after clicking on the corresponding user input in a prior screen 1160. The screen 1170 includes a first section 1172 illustrating details about the subscription service being used and providing a link to edit the subscription service. Section 1174 shows details regarding a planned automatic order option, and includes an option to initiate an order. Section 1176 shows a recent order history. Section 1178 shows the tracking devices that correspond to the tracked consumable product and the planned order.

### Example Flowchart(s)

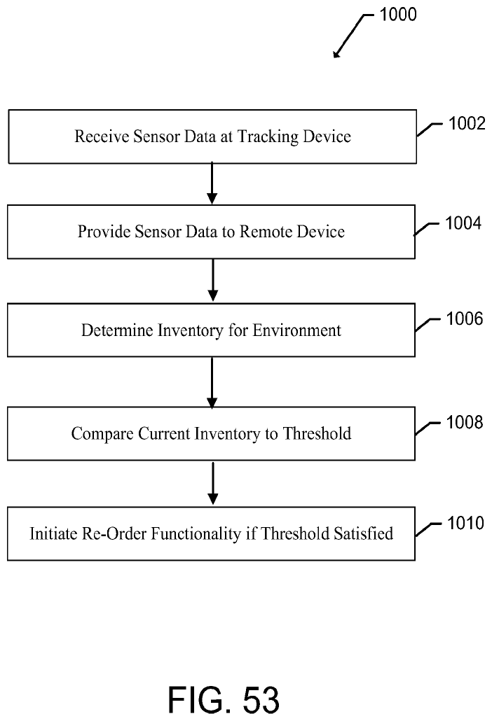

Embodiments of the present invention provide methods, apparatuses and computer program products for providing automatic tracking and re-order functionality according to various embodiments described herein. Various examples of the operations performed in accordance with embodiments of the present invention will now be provided with reference to FIG. 53.

FIG. 53 illustrates a flowchart according to an example method for providing automatic tracking and re-order functionality according to an example embodiment. The operations illustrated in and described with respect to FIG. 53 may, for example, be performed by, with the assistance of, and/or under the control of one or more of the components, architectures, modules, networks, and/or systems/devices of system 11, 11′, such as described herein.

The method 1000 may include receiving sensor data at one or more tracking device(s) at operation 1002, such as described in various embodiments herein. At operation 1004, the method may include providing the sensor data to a remote device, such as described in various embodiments herein. At operation 1006, the method may include determining an inventory for a corresponding one or more consumable products for a household environment, such as described in various embodiments herein. Then, the method may include comparing the inventory count to a threshold amount for triggering re-order functionality at operation 1008, and, at operation 1010, initiating the re-order functionality if the threshold is satisfied, such as described in various embodiments herein.

FIG. 53 illustrates an example flowchart of a system, method, and computer program product according to various example embodiments described herein. It will be understood that each block of the flowcharts, and combinations of blocks in the flowcharts, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by, for example, the memory and executed by, for example, various controller(s) within the system. As will be appreciated, any such computer program product may be loaded onto a computer or other programmable apparatus to produce a machine, such that the computer program product including the instructions which execute on the computer or other programmable apparatus creates means for implementing the functions specified in the flowchart block(s). Further, the computer program product may comprise one or more non-transitory computer-readable mediums on which the computer program instructions may be stored such that the one or more computer-readable memories can direct a computer or other programmable device to cause a series of operations to be performed on the computer or other programmable apparatus to produce a computer-implemented process such that the instructions which execute on the computer or other programmable apparatus implement the functions specified in the flowchart block(s).

### CONCLUSION

Many modifications and other embodiments of the inventions set forth herein may come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

1. A system for providing automatic tracking and re-order functionality for an environment, the system comprising:
a first consumables device configured to hold a quantity or level of first consumables, wherein the first consumables device comprises:
a first consumables sensor configured to determine occurrence of a change in the quantity or level of the first consumables within the first consumables device; and
a first consumables communication interface configured to transmit first sensor data of the first consumables sensor to a remote device;
a second consumables device configured to hold a quantity or level of second consumables, wherein the second consumables are different than the first consumables, wherein the second consumables device comprises:
a second consumables sensor configured to determine occurrence of a change in the quantity or level of the second consumables within the second consumables device; and
a second consumables communication interface configured to transmit second sensor data of the second consumables sensor to the remote device;
the remote device comprising a processor configured to:
receive the first sensor data and the second sensor data;
determine a current inventory status corresponding to the quantity or level of the first consumables currently in the environment;
determine a current inventory status corresponding to the quantity or level of the second consumables currently in the environment; and
perform re-order functionality for the first consumables in an instance in which the current inventory status corresponds to a threshold re-order inventory status for the first consumables, wherein the re-order functionality comprises a semi-automated re-order function, wherein the semi-automated re-order function corresponds to providing an option for a user to initiate the order to replenish the first consumables, wherein the option requires user interaction prior to initiating the order to replenish the first consumables; and
perform re-order functionality for the second consumables in an instance in which the current inventory status corresponds to a threshold re-order inventory status for the second consumables, wherein the re-order functionality comprises one of an automated re-order function, a semi-automated re-order function, or a manual re-order function, wherein the automated re-order function corresponds to automatic initiation of an order to replenish the second consumables, wherein the semi-automated re-order function corresponds to providing an option for a user to initiate the order to replenish the second consumables, and wherein the manual re-order function corresponds to providing a notification to the user that the current inventory status of the second consumables corresponds to threshold re-order inventory status of the second consumables so as to remind the user to replenish the second consumables.

2. The system of claim 1 further comprising a software application installed on a user computing device, wherein the remote device is configured to:
transmit, in conjunction with the semi-automated re-order function for the first consumables, a notification to the software application providing the option, via the software application, to initiate the order to replenish the first consumables.

3. The system of claim 2, wherein, in conjunction with the semi-automated re-order function for the first consumables, the notification indicates that the current inventory status of the first consumables in the environment corresponds to the threshold re-order inventory status for the first consumables, and wherein, in conjunction with the semi-automated re-order function for the second consumables, the notification indicates that the current inventory status of the second consumables in the environment corresponds to the threshold re-order inventory status for the second consumables.

4. The system of claim 2, wherein the software application enables the user to modify the re-order functionality for the first consumables to select one of an automated re-order function, the semi-automated re-order function, or the manual re-order function.

5. The system of claim 2, wherein the remote device is configured to determine the current inventory status corresponding to the quantity or level of the first consumables currently in the environment based on the first sensor data and an estimated or inputted amount of extra first consumables stored within the environment.

6. The system of claim 5, wherein the software application enables the user to input the amount of extra first consumables stored within the environment.

7. The system of claim 5, wherein the remote device is configured to update the estimated or inputted amount of extra first consumables stored within the environment based on received shipments of replacement first consumables.

8. The system of claim 5, wherein the remote device is further configured to update the amount of extra first consumables stored within the environment based on the occurrence of a change in the quantity or level of the first consumables within the first consumables device.

9. The system of claim 1, wherein the remote device is configured to determine the current inventory status corresponding to the quantity or level of the first consumables currently in the environment based on a plurality of first consumable devices within the environment.

10. The system of claim 9, wherein the plurality of first consumable devices within the environment comprises at least one first type of first consumable device and at least one second type of first consumable device, wherein the first type of first consumable device and the second type of first consumable device comprise different types of sensors configured to sense first consumables.

11. The system of claim 9, wherein the plurality of first consumable devices within the environment comprises at least one first type of first consumable device and at least one second type of first consumable device, wherein the first type of first consumable device is configured to store replacement first consumables, wherein the second type of first consumable device is configured to enable dispensing of first consumables.

12. The system of claim 1, wherein the occurrence of the change in the quantity or level of the first consumables corresponds to one of installation in or removal of a tissue paper roll from the first consumables device.

13. The system of claim 12, wherein the second consumables are one of napkins or plates.

14. The system of claim 12, wherein the second consumables are paper towel.

15. The system of claim 12, wherein the second consumables are loose bulk storage products.

16. The system of claim 1, wherein the remote device comprises one of a remote server or a remote computing device positioned within the environment.

17. A method for providing automatic tracking and re-order functionality for an environment, the method comprising:
receiving first sensor data from a first consumables device configured to hold a quantity or level of first consumables, wherein the first consumables device comprises:
a first consumables sensor configured to determine occurrence of a change in the quantity or level of the first consumables within the first consumables device; and
a first consumables communication interface configured to transmit first sensor data of the first consumables sensor to a remote device;
receiving second sensor data from a second consumables device configured to hold a quantity or level of second consumables, wherein the second consumables are different than the first consumables, wherein the second consumables device comprises:
a second consumables sensor configured to determine occurrence of a change in the quantity or level of the second consumables within the second consumables device; and
a second consumables communication interface configured to transmit second sensor data of the second consumables sensor to the remote device;
determining a current inventory status corresponding to the quantity or level of the first consumables currently in the environment;
determining a current inventory status corresponding to the quantity or level of the second consumables currently in the environment; and
performing re-order functionality for the first consumables in an instance in which the current inventory status corresponds to a threshold re-order inventory status for the first consumables, wherein the re-order functionality comprises a semi-automated re-order function, wherein the semi-automated re-order function corresponds to providing an option for a user to initiate the order to replenish the first consumables, wherein the option requires user interaction prior to initiating the order to replenish the first consumables; and
performing re-order functionality for the second consumables in an instance in which the current inventory status corresponds to a threshold re-order inventory status for the second consumables, wherein the re-order functionality comprises one of an automated re-order function, a semi-automated re-order function, or a manual re-order function, wherein the automated re-order function corresponds to automatic initiation of an order to replenish the second consumables, wherein the semi-automated re-order function corresponds to providing an option for a user to initiate the order to replenish the second consumables, and wherein the manual re-order function corresponds to providing a notification to the user that the current inventory status of the second consumables corresponds to threshold re-order inventory status of the second consumables so as to remind the user to replenish the second consumables.

18. The method of claim 17, further comprising transmitting, in conjunction with the semi-automated re-order function for the first consumables, a notification to a software application installed on a user computing device, wherein the notification provides the option, via the software application, to initiate the order to replenish the first consumables.

19. The method of claim 17, wherein determining the current inventory status corresponding to the quantity or level of the first consumables currently in the environment is further based on an estimated or inputted amount of extra first consumables stored within the environment.

20. A computer program product comprising a non-transitory computer readable medium including computer program code configured to, with a processor, cause a computing device for providing automatic tracking and re-order functionality for an environment to:
receive first sensor data from a first consumables device configured to hold a quantity or level of first consumables, wherein the first consumables device comprises:
a first consumables sensor configured to determine occurrence of a change in the quantity or level of the first consumables within the first consumables device; and
a first consumables communication interface configured to transmit first sensor data of the first consumables sensor to a remote device;
receive second sensor data from a second consumables device configured to hold a quantity or level of second consumables, wherein the second consumables are different than the first consumables, wherein the second consumables device comprises:
a second consumables sensor configured to determine occurrence of a change in the quantity or level of the second consumables within the second consumables device; and
a second consumables communication interface configured to transmit second sensor data of the second consumables sensor to the remote device;
determine a current inventory status corresponding to the quantity or level of the first consumables currently in the environment;
determine a current inventory status corresponding to the quantity or level of the second consumables currently in the environment; and
perform re-order functionality for the first consumables in an instance in which the current inventory status corresponds to a threshold re-order inventory status for the first consumables, wherein the re-order functionality comprises a semi-automated re-order function, wherein the semi-automated re-order function corresponds to providing an option for a user to initiate the order to replenish the first consumables, wherein the option requires user interaction prior to initiating the order to replenish the first consumables; and
perform re-order functionality for the second consumables in an instance in which the current inventory status corresponds to a threshold re-order inventory status for the second consumables, wherein the re-order functionality comprises one of an automated re-order function, a semi-automated re-order function, or a manual re-order function, wherein the automated re-order function corresponds to automatic initiation of an order to replenish the second consumables, wherein the semi-automated re-order function corresponds to providing an option for a user to initiate the order to replenish the second consumables, and wherein the manual re-order function corresponds to providing a notification to the user that the current inventory status of the second consumables corresponds to threshold re-order inventory status of the second consumables so as to remind the user to replenish the second consumables.

21-91. (canceled)
